(19) United States
(12) Patent Application Publication
(10) Pub. No.: US 2024/0184038 A1
(43) Pub. Date: Jun. 6, 2024

(54) OPTICAL WAVEGUIDE, OPTICAL WAVEGUIDE SYSTEM, LIGHT CONFINING STRUCTURES, LIGHT ENERGY STORAGE STRUCTURE, LIGHT ENERGY STORAGE SYSTEM, AND ENERGY STORAGE AND/OR CONVERSION SYSTEM

(71) Applicant: PERA Complexity, B.V., Amsterdam (NL)

(72) Inventor: Aluizio M. Cruz, Long Beach, CA (US)

(21) Appl. No.: 18/553,987

(22) PCT Filed: Apr. 5, 2022
(86) PCT No.: PCT/EP2022/058979

§ 371 Date: Oct. 4, 2023

(30) Foreign Application Priority Data
Apr. 5, 2021 (EP) 21166866.0

(51) Int. Cl. G02B 6/02; B82Y 20/00; G02B 1/00; G02B 5/00; G02B 26/00; G02F 1/00; G02F 1/07

(52) U.S. Cl. CPC G02B 6/02052; B82Y 20/00; G02B 1/002; G02B 5/008; G02B 6/021; G02B 26/002; G02B 26/004; G02F 1/0054; G02F 1/073

(57) ABSTRACT

The present application is directed in various illustrative embodiments to an optical waveguide, an optical waveguide system with such an optical waveguide, a light energy storage structure, light confining structures, a light energy storage system and an energy storage and/or conversion system with such an optical waveguide system. In an aspect, an optical waveguide is provided, comprising an optical fiber with a fiber core and an optical active cladding structure over at least a portion of the fiber core at a first end of the optical waveguide, wherein the optical active cladding structure comprises a Bragg mirror stacking having a high transmittance in a first wavelength region and a high reflectivity in a second wavelength region of wavelengths longer than wavelengths in the first wavelength region, and a wavelength conversion coating over the fiber core of the optical fiber. The wavelength conversion coating is configured to convert radiation with wavelengths in the first wavelength region into radiation with wavelengths in the second wavelength region and the Bragg mirror stacking is disposed over the wavelength conversion coating.

### FIELD OF THE INVENTION

The present application relates to an optical waveguide, an optical waveguide system, a light energy storage structure, light confining structures, a light energy storage system, and an energy storage and/or conversion system. In particular, the present application relates to an optical waveguide with an optical fiber and an optical active cladding structure to be used in an optical waveguide system, and to an energy storage system with such an optical waveguide system.

### BACKGROUND

Energy, in its different forms, is of fundamental importance for life and development in our world as any living organism needs energy to stay alive. Also energy is fundamental, not only for the essential needs of organisms but also to civilization, where technology and development affect the coexistence of human beings in our world. One of the fundamental grounds on which technology and development can evolve, is given by power generation and distribution which needs to satisfy the increasing demand of energy that goes along with the increasing impact that technology and development have in our lives.

Due to growing pollution concerns from fossil fuels as an energy source, there has been a large increase in international agreements and national energy action plans to increase the use of renewable energy. Although the sun is the fundamental source of energy for life on earth to exist, the world's electricity generation based on solar energy only covers a very small part of the total world electricity generation. One of the main challenges for solar energy to be used in the generation of electricity is the high cost to furnish an electric power unit based on solar energy. General strategies to improve this situation are directed to either increase the efficiency of electrical power generation in solar cells or to reduce power losses in the power transmission from the power sources to power consumers.

A basic idea on which the subject matter of the present application is based is directed to the transmission of photonic energy in optical waveguides and the confinement of light. Conventionally, optical waveguides are used in the transmission of optical data instead of transmitting data on the basis of electrical signals.

In view of known optical waveguides, it is an object of the present invention to provide an optical waveguide with improved efficiency to transmit optical energy. Furthermore, it is an objective to provide an improved waveguide system and energy storage and/or conversion system with such a waveguide system relying on such improved optical waveguide.

### BRIEF SUMMARY

The above object is solved in various aspects by an optical waveguide in accordance with independent claim 1, an optical waveguide system in accordance with claim 10, a light confining structure in accordance with claim 12, a light confining structure in accordance with claim 29, a light energy storage structure in accordance with claim 33, a light energy storage system in accordance with claim 36, and an energy storage and/or conversion system in accordance with claim 37. More advantageous embodiments thereof are defined in the further enclosed dependent claims 2 to 9, 11, 13 to 28, 30 to 32, 34 to 35, and 38 to 44.

In a first aspect of the present disclosure, an optical waveguide is provided. In accordance with illustrative embodiments of the first aspect, the optical waveguide comprises an optical fiber with a fiber core and an optical active cladding structure over at least a portion of the fiber core at a first end of the optical waveguide. Herein, the optical active cladding structure comprises a Bragg mirror stacking having a high transmittance in a first wavelength region and a high reflectivity in a second wavelength region of wavelengths longer than wavelengths in the first wavelength region, and a wavelength conversion coating over the fiber core of the optical fiber, the wavelength conversion coating being configured to convert radiation with wavelengths in the first wavelength region into radiation with wavelengths in the second wavelength region. In these embodiments, the Bragg mirror stacking is disposed over the wavelength conversion coating.

Such an optical waveguide shows an improved optical transmission property due to the optical active cladding structure over the optical fiber as well as an improved optical harvesting which becomes possible due to the optical active cladding structure over at least a portion of the fiber core at the first end of the optical waveguide. In particular, the optical active cladding structure makes it possible that light is coupled into the optical waveguide via the optical active cladding structure, thereby providing a lateral surface as an input surface for coupling light into the optical waveguide. Depending on the size of the portion covered by the optical active cladding structure at the first end of the optical waveguide, light may be more effectively harvested by the optical waveguide as compared to coupling of light into an optical waveguide along an optical axis of an optical waveguide. The reason is that the size of the portion used as a light harvesting surface of an optical waveguide may be selected independently from a radius and particularly a cross-section of an optical waveguide.

In accordance with some illustrative embodiments of the first aspect, the wavelength conversion coating may comprise a wavelength conversion dye that is configured to emit radiation with wavelengths in the second wavelength region by stimulated emission upon being irradiated with radiation with wavelengths in the first wavelength region. The use of stimulated emission allows to avoid re-emission. Additionally or alternatively, the first wavelength region may be located between about 380 nm and about 700 nm and the second wavelength region may be located between about 700 nm and about 1.4 μm, such as in a range from about 700 nm to about 880 nm or in the range from about 750 nm to about 1.4 μm. The use of a wave length conversion coating comprising a wavelength conversion dye that is configured to emit radiation with wavelengths in the second wavelength region by stimulated emission makes it possible to reduce light losses while maintaining coherence of the radiation emitted by stimulated emission. Accordingly, transmission of near IR light in the optical waveguide is possible, which could be advantageously employed in diversity of sectors, such as for biological, medical, agricultural applications, as well as solar-based vertical desalination and solar fuels. However, this is not limiting and the first wavelength region may be defined by wavelengths smaller than about 300 nm, while the second wavelength region may be given by wavelengths in the range of about 300 nm to about 400 nm, thereby allowing the waveguide to transmit UV light which may be used as UV light sources in indoor farming. For example, the first and second wavelength regions, being located from approximately 380 to about 1.4 μm, allow using a part of the spectrum of solar light of a comparatively high spectral irradiance. In some illustrative examples, the first wavelength region may cover the visible light together with a portion of the UV spectrum, while the second wavelength regions may cover a portion of the red light towards the infrared light without being subjected to O₂ and H₂O absorption bands in the solar spectrum when being given by wavelengths in the region from about 700 nm to about 880 nm. In effect, the red and infrared part of the solar spectrum, substantially without any absorption bands, may be transmitted within the optical waveguide at a spectral irradiance of the peak at the visible light region.

In accordance with some illustrative embodiments of the first aspect, the optical fiber may have an air core and a glass or polymeric cladding bordering the air core. An air core fiber provides the advantage that light transmitted via the air core experiences less damping than light transmitted in optical fibers having a glass or polymeric core.

In accordance with some illustrative embodiments of the first aspect, the wavelength conversion coating may be configured to enhance fluorescence via a plasmonic enhancement function with surface plasmons. In plasmonic enhancement, light interacts with nanostructures generating electromagnetic fields that enhance the sensitivity of fluorescence-based materials like a dye. In an illustrative example herein, periodic metal or metamaterial or non-metal nanoparticle configuration/arrays with long range diffractive coupling support lattice plasmons with narrow resonances may be used. In accordance with some illustrative examples, a geometry of core/shell nanoparticles may incorporate a tunable diameter ranging from about 5 nm to about 100 nm, where a shell (e.g., made of silica or SiO₂) may range in thickness from about 1 nm to about 80 nm.

In some illustrative examples of the above described illustrative embodiments, the wavelength conversion coating may comprise a nanoparticle film formed of metal nanoparticles such as gold cores and/or silver cores disposed on the optical fiber. In a special illustrative example herein, the wavelength conversion coating may comprise a nanoparticle structure comprising gold cores of about 15 nm with a silica shell of about 7.5 nm. Accordingly, an enhancement of the stimulate emission may be employed by including a nanoparticle film into the wavelength conversion coating and the wavelength conversion coating may provide a good adhesion to the optical fiber and to the Bragg mirror stacking in the optical active cladding structure.

In accordance with some illustrative embodiments of the first aspect, the wavelength conversion coating may further comprise a silicon oxide or silica matrix material which covers the nanoparticle film and over which the Bragg mirror stacking is disposed. Additionally or alternatively, the nanoparticle film may have a thickness in a range from about 500 nm to about 3 μm, preferably in the range from about 1 μm to about 2 μm, more preferably in the range from about 1.1 μm to about 1.5 μm such as having a thickness of about 1.2 μm. The silicone oxide matrix material may provide a spacer or a plasmonic nanolaser between the nanoparticle cores of particle film and the wavelength conversion dye of the wavelength conversion coating. Furthermore, an improved adhesion of the wavelength conversion dye on the nanoparticle film maybe realized by the silicone oxide matrix material. Additionally or alternatively, the thickness of the nanoparticle film realizes an advantageous optical density of the nanoparticle film.

In accordance with some illustrative embodiment of the first aspect, the optical active cladding structure may be formed such that the optical fiber is at least partially covered by the wavelength conversion coating in a region at the first end. This is, advantageously, a portion of the cladding of the optical waveguide which serves as a light harvesting surface. Furthermore, by only covering the optical fiber by the wavelength conversion coating in a region at the first end, a fabrication of the optical waveguide may be simplified and fabrication costs may be reduced.

In accordance with some illustrative embodiment of the first aspect, the optical fiber may be completely covered by the Bragg mirror coating along its entire length and/or its entire circumference. Accordingly, light transmitted in the optical waveguide may be confined to the optical waveguide along its entire length and/or its entire circumference.

In accordance with some illustrative embodiment of the first aspect, the optical waveguide may have a length in the range from about 5 nm to about 7500 km. Compared to conventional optical waveguides, the optical waveguides according to these embodiments of the first aspect are fabricated for long length. So far, conventional air core fibers can only be fabricated with a length of up to 860 m for multimode optical fibers at 850 nm and considering TIA and IEEE standards based on worse case assumptions, while a length up to 40 km for single mode optical operating at 1310 nm at the speed of 40 gigabit is possible. By contrast, an optical waveguide according to the illustrative embodiments of the present invention may be provided with advantageous lengths up to several 1000 km.

In accordance with a second aspect of the present disclosure, an optical waveguide system is provided. In illustrative embodiments herein, the optical waveguide system comprises plural ones of the optical waveguide of the first aspect, wherein at least some of the optical waveguides are arranged so as to cover a two-dimensional area at the first ends of these optical waveguides. Herein, the first ends of these optical waveguides are arranged substantially in parallel at their first ends. Accordingly, a two-dimensional or even three-dimensional light harvesting region of the optical waveguide system may be provided.

In some illustrative embodiments of the second aspect, the optical waveguides may comprise a first subset of optical waveguides with their first ends being arranged in parallel and a second subset of optical waveguides with their first ends being arranged in parallel, wherein the optical waveguides of the first and second subsets are interwoven at their first ends such that the optical waveguides of the first subset extend across the optical waveguides of the second subset at their first ends. An interwoven or interleafed arrangement of optical waveguides represents an advantageous two-dimensional light harvesting region. Accordingly, arbitrary light harvesting areas may be manufactured using the optical waveguide system.

In a third aspect of the present disclosure, a light energy storage structure is provided. In some illustrative embodiments herein, the light energy storage structure comprises a porous membrane body formed of a dielectric material and nanoparticles deposited on at least a surface portion of the porous membrane body. Such a light energy storage structure allows to capture and store light energy for further use. The basic idea is to use a disordered structure provided by the porous membrane body with the nanoparticles, for trapping light within the light storage structure and thereby storing light energy in the light energy storage structure. The light energy stored in this way may be kept until it is triggered by an external optical pulse which fulfils a certain condition for allowing stored light to escape from the light energy storage structure.

In accordance with some illustrative embodiments herein, the nanoparticles may have a maximum size of less than about 300 nm. Accordingly, an advantageous elastic scattering process may take place at the nanoparticles. Additionally or alternatively, the nanoparticles may have a sphere-like or semi sphere like shape which advantageously affects the scattering at the nanoparticles. Additionally or alternatively, a spacing between nanoparticles may be at least about 2.048 times an average radius of the nanoparticles which results in a chaotic or disordered scattering based on the idea that unstable periodic orbits of scattered light proliferate exponentially which means that a chaotic scattering with a so-called hyperbolic invariant set is provided. Additionally or alternatively, the nanoparticles may be formed of at least one of silica glass, ferritin, heat-shock proteins, vault proteins and protein nanocages which provide for advantageous examples of suitable nanoparticles.

In accordance with some illustrative embodiments herein, the porous membrane body may be formed of at least one of TiO₂ and SiO₂. These materials represent illustrative examples of heat resistive material that avoids loss of energy due to absorbance of stored light over time.

In a fourth aspect of the present disclosure, a light energy storage system is provided. In illustrative embodiments herein, the light energy storage system may comprise the optical waveguide system of the second aspect and at least one of a light energy storage structure of the third aspect, the light confining structure of the fifth aspect as disclosed below, and the light confining structure of the sixth aspect as described below at each end of the optical waveguide system. In such a system, one light energy storage system may be advantageously used as a light collector, collected light being transported by the optical waveguide system to another light energy storage structure where the transmitted light energy is stored.

In a fifth aspect of the present disclosure, a light confining structure that relies on a disordered geometry structure is provided. In illustrative embodiments herein, the light confining structure comprises a substrate of a non-absorbing material, nanophotonic resonators provided by one of a structure of nanophotonic cavities formed in a surface of the substrate and a structure of quantum dots formed on the surface of the substrate, and a micro- or nanoparticle structure formed on the surface of the substrate, wherein the micro- or nanoparticle structure comprises shells of low relative permittivity smaller 1 and cores of a dielectric material, each shell enclosing at least two cores on the surface of the substrate. A disordered geometry structure indicates a level of disorder in the nanophotonic resonator structure in that a parameter of the nanophotonic resonators, such as a density or filling fraction, has a minimum variance greater zero such as at least a variance of at least five percent. Accordingly, light may be harvested.

In accordance with illustrative embodiments of the fifth aspect, the shells may be formed of an optically transparent dielectric matrix material.

In accordance with illustrative embodiments of the fifth aspect, the shells may have a relative permittivity smaller 0.5 or smaller 0.2 or smaller 0.1 or smaller 0.05.

In accordance with illustrative embodiments of the fifth aspect, the substrate may be formed of one of a rigid membrane, a flexible membrane, a rigid film and a flexible film.

In accordance with illustrative embodiments of the fifth aspect, the shells may be formed of a dielectric material or a plasmonic material.

In accordance with illustrative embodiments of the fifth aspect, the shells may be formed of a metallic or non-metallic plasmonic material.

In accordance with illustrative embodiments of the fifth aspect, the cores may be made of one of porcelain, mica, and quartz, or an organic material, preferably an organic polymer.

In accordance with illustrative embodiments of the fifth aspect, the cores may have core diameter of in a range from about 100 nm to about 1 μm.

In accordance with illustrative embodiments of the fifth aspect, the shells may be of a size greater than 100 nm and/or cores enclosed by shells have a nearest neighbor separation in a range from about 100 nm to about 1 μm.

In accordance with illustrative embodiments of the fifth aspect, the cores may be provided in the shape of at least one of a cylindrical shape and an ellipsoidal shape and a nanorod shape and a spherical shape and a nanotube shape and a nanowire shape.

In accordance with illustrative embodiments of the fifth aspect, the shells may be provided in the shape of at least one of a semi-spherical shape and a semi-ellipsoidal shape.

In accordance with illustrative embodiments of the fifth aspect, the cores may be enclosed by a shell are arranged in a substantially linear arrangement.

In accordance with illustrative embodiments of the fifth aspect, the nanophotonic resonators may be provided by a structure of quantum dots formed of InAs quantum dots, at least some of which having nanophotonic cavities formed therein.

In accordance with illustrative embodiments of the fifth aspect, the nanophotonic resonators may be provided by a structure of holes formed in the substrate.

In some illustrative examples herein, the holes may be substantially circular holes having a diameter in the range from about 100 nm to about 500 nm, preferably in the range from about 100 nm to about 300 nm or in a range from about 150 nm to about 500 nm, and more preferably in a range from about 150 nm to about 300 nm.

In accordance with illustrative embodiments of the fifth aspect, the nanophotonic resonators may be provided with a filling fraction of about 50% to 85% and/or the shells may have a center diameter in the range of 200-400 nm and/or cores enclosed by shells may have a nearest neighbor separation in a range of 460-700 nm.

In accordance with illustrative embodiments of the fifth aspect, the filling fraction may have a variance in a range of about 5% to about 20% and/or the center diameter may have a variance of 10% to about 40% and/or the nearest neighbor separation may have a variance in a range of about 10% to about 40%.

In a sixth aspect of the present disclosure, a light confining structure is provided. In illustrative embodiments herein, the light confining structure comprises a substrate of a non-absorbing material, and a micro- or nanoparticle structure formed on the surface of the substrate, wherein the micro- or nanoparticle structure comprises micro- or nanoparticles arranged in at least one agglomeration of a regular polygonal or polyhedral shape where the micro- or nanoparticles are located on vertices of the polygonal shape or polyhedral shape. Accordingly, light may be harvested.

In accordance with illustrative embodiments of the sixth aspect, a nearest neighbor separation of the nanoparticles in each agglomeration may have a separation of at least 2.048 times an average radius of the nanoparticles.

In accordance with illustrative embodiments of the fifth and/or sixth aspect, the nanoparticles may have an average radius of at most 150 nm.

In applications according to some illustrative embodiments of the fifth and/or sixth aspect, the light confining structure may be mounted on a solar cell or solar cell arrangement and the like. Accordingly, efficiency of light harvesting may be increased.

In accordance with illustrative embodiments of the sixth aspect, the substrate may be formed of at least one of TiO₂ and SiO₂. Additionally or alternative, the substrate may be a porous membrane body formed of a dielectric material and having nanoparticles deposited on at least a surface portion of the porous membrane body and/or the nanoparticles may be formed of at least one of silica glass, ferritin, heat-shock proteins, vault proteins and protein nanocages. Accordingly, a substrate may be provided cost-efficiently and/or processed in a simple manner.

In a seventh aspect of the present disclosure, an energy storage and/or conversion system is provided. In accordance with some illustrative embodiment of the fifth aspect, the energy storage and/or conversion system comprises a container for storing therein a liquid, wherein the container has an inner surface being composed of a nonlinear juxtaposition of heat resistance ceramic tiles and/or the container contains a liquid comprising microstructures and/or nanostructures dispersed in the liquid for confining electromagnetic radiation, and/or highly conductive composites and graphite immersed therein. For example, the container may be composed of insulation, surface lining and heat treatment materials such as refractory bricks or fire bricks. In some special illustrative examples herein, such bricks can be composed of elements such as magnesium oxide for low temperatures, and with elements such as silica for high temperatures. It is also possible to additionally or alternative employ high-temperature (i.e., above 1000° C.) reusable insulators such as HRSI titles and/or high heat resistant refractory ceramics including Tantalum carbide (TaC) and hafnium carbide (HfC) as materials for forming at least inner surface walls of the container. Such an energy storage and conversion system may be used for confining electromagnetic radiation in the container for purposes of energy storage and/or conversion.

In accordance with some illustrative embodiments of the seventh aspect, energy storage and/or conversion system may further comprise the optical waveguide system of the second aspect, wherein a liquid is stored in the container, wherein a second end of the optical waveguide system opposite the first ends is arranged so as to direct radiation emitted from the optical waveguide system into the liquid, or may further comprise the light energy storage system according to the fourth aspect, for example, the light confining structure being in contact with the liquid or on top of the container. Furthermore, the liquid may comprise in some illustrative examples herein, highly conductive composites and/or graphite immersed therein. Such an energy storage and/or conversion system may efficiently use optical energy transmitted by the optical waveguide system for generating and storing heat in the container.

In some illustrative embodiments of the seventh aspect, the highly conductive composites may be made of phase change materials such as a nitrate salt mixture and/or carbon moieties and/or the liquid may further comprise nanoparticles, such as nanoparticles having gold cores and/or silver cores and/or nanoparticles comprising copper nanoparticles and/or copper oxide nanoparticles immersed therein. Such an implementation of highly conductive composites and nanoparticles may provide an efficient absorption of light energy in the liquid.

In accordance with some illustrative embodiments of the seventh aspect, the thermal capacity of the liquid may be equal to or smaller than that of water. For example, the liquid may be water or a liquid having a thermal capacity similar to the thermal capacity of water or smaller than that of water. Accordingly, a good heating of water may be implemented in a system in which the heat of the liquid is used for generating electrical energy, for example. Additionally or alternatively, the liquid may have a low enthalpy of vaporization which means that optical energy may be efficiently used for vaporizing the liquid and the vaporized liquid may be further used for generating electrical energy by means of a turbine when using the energy storage and/or conversion system in a system for generating electrical power, for example. In case that the energy storage and/or conversion system is used as a thermal energy storage, the liquid has preferably a high enthalpy of vaporization and a high thermal capacity, preferably equal to or higher than the enthalpy of vaporization of water and the thermal heat capacity of water.

In accordance with some illustrative embodiments of the seventh aspect, the microstructures and/or nanostructures dispersed in the liquid may be composed of cores and filaments acting as shells for the cores. For example, the cores may be provided by deformed spheres. In some illustrative examples, the filaments may be provided in a network of filaments having a filament diameter of about 244 nm±50 nm, a nearest neighbor separation of about 580 nm±120 nm, and a mean scale void filling fraction (e.g., a ratio of the volume of void-space to the total volume) of about 68%±7%. In some special examples, the nanostructures may comprise chitin (or an equivalent polymer with refractive index of 1.56) and/or air and/or blends of TiO₂ and latex spheres of similar diameters

In accordance with some illustrative embodiments of the seventh aspect, a separation between the first and second ends may be in the range from about 5 nm to about 7500 km. Accordingly, transmittance of photonic energy to an energy storage and/or conversion system over long distances may be established.

In accordance with some illustrative embodiments of the seventh aspect, the optical waveguide system may comprise a first optical waveguide used for transporting optical energy and a second optical waveguide used for transporting optical data. For example, the second optical waveguide may comprise data terminals which may be connected with a data system. For example, the second optical waveguide may serve as a data transportation fiber. Accordingly, an optical waveguide as provided in the first aspect, may serve as a hybrid waveguide configured to transport optical energy in an energy storage and/or conversion system and optical data in a data transmission system.

In accordance with some illustrative embodiments of the seventh aspect, the light energy storage structure of the third aspect may be arranged in the container. Accordingly, the light energy storage structure may release the stored energy within the container such that the energy conversion system of the fifth aspect in these illustrative embodiments may advantageously interact with the light energy storage structure such that liquid within the container may cause the release of the light energy stored within the light energy storage structure such that the released energy may be converted into thermal energy by means of liquid contained in the container.

In accordance with some illustrative embodiments of the seventh aspect, the energy storage and/or conversion system may further comprise the light confining structure of at least one of the fifth and sixth aspects described above arranged in and/or optically coupled to the container. Additionally or alternatively, the energy storage and/or conversion system may further comprise the light energy storage structure of the fourth aspect arranged in and/or optically coupled to the container. Accordingly, an optical efficiency of the energy storage and/or conversion system may be improved and light harvesting may be increased by onsite harvesting without the need of a transmittal structure.

In accordance with some illustrative embodiments of the seventh aspect, the energy storage and/or conversion system may further comprise at least one connection terminal configured for connecting the energy storage and/or conversion system with at least one exterior energy supply system. Accordingly, thermal and/or electric energy provided by the energy storage and/or conversion system may be provided as supplying consumers with energy. In some illustrative examples herein, the at least one connection terminal may be configured for connecting the energy storage and/or conversion system with at least one of a steam supply system and an electric energy grid such that thermal and/or electric energy may be supplied to an according infrastructure. For example, the at least one connection terminal may be configured for connecting with a thermal energy feedback system such that at least one connection terminal may be provided as a feedback connection terminal so as to reduce energy waste by storing energy fed back to the energy storage and/or conversion system.

Embodiments of the first aspect and/or second aspect represent illustrative examples of a light energy complex propagation system which the inventor refers to as “LINERGY”.

Embodiments of the third aspect and/or fifth aspect and/or sixth aspect represent illustrative examples of an optical energy storage which the inventor refers to as “OPERAS”.

Embodiments of the seventh aspect represent illustrative examples of a hydro-colloid absorbing system which the inventor refers to as “HYDRAS”.

Further advantageous and features of the present invention will become clear from the following description of some illustrative embodiments.

### BRIEF DESCRIPTION OF THE DRAWINGS

In the following, some illustrative embodiments of the present disclosure will be described in greater detail with regard to the accompanying drawings, which are not to scale and in which:

FIG. 1 schematically shows an optical waveguide in accordance with some illustrative embodiments of the present disclosure;

FIG. 2 schematically shows a cross sectional view of an enlarged portion of the optical waveguide of FIG. 1;

FIG. 3 schematically shows in diagrams a relation between spectral irradiance and wavelength of solar light in comparison to transmission characteristic of a Bragg mirror stacking in accordance with some illustrative embodiments of the present disclosure;

FIG. 4 schematically shows a diagram of a relation between transmission and wavelength of a Bragg mirror stacking in accordance with various illustrative embodiments of the present disclosure independence on light irradiation at different angles;

FIG. 5 schematically shows a scheme for stimulated emission in a three-level system;

FIGS. 6a and 6b show different embodiments of a nanoparticle film in accordance with various illustrative embodiments of the present disclosure;

FIG. 7 schematically shows a relation between optical density and wavelength for different sized nanoparticles in accordance with various illustrative embodiments of the present disclosure;

FIG. 8 schematically shows an effect of Bragg mirror stacking on an optical fiber in the context of various illustrative embodiments of the present disclosure;

FIG. 9 schematically shows a fabrication system for forming an optical active cladding structure on an optical fiber in accordance with various illustrative embodiments of the present disclosure;

FIG. 10 schematically shows an optical waveguide system in accordance with various illustrative embodiments of the present disclosure;

FIGS. 11a and 11b schematically show an optical waveguide system in accordance with various illustrative embodiments of the present disclosure;

FIG. 12 schematically shows an energy storage and/or conversion system in accordance with various illustrative embodiments of the present disclosure;

FIG. 13 schematically shows an enlarged portion of the core of the energy storage and/or conversion system in FIG. 12;

FIG. 14 schematically shows a light energy storage structure in accordance with some illustrative embodiments;

FIG. 15 schematically shows an energy storage and/or conversion system in accordance with some alternative illustrative embodiments;

FIG. 16 schematically shows an energy storage and/or conversion system in accordance with some other alternative illustrative embodiments;

FIG. 17 schematically shows a top view onto an enlarged portion of a light confining structure in accordance with some illustrative embodiments of the present disclosure;

FIG. 18a schematically shows an arrangement of three spherical nanoparticles on a surface of a substrate of a light confining structure in accordance with some illustrative embodiments of the present disclosure;

FIGS. 18b to 18f schematically shows 3D arrangements of plural nanoparticles in accordance with some further illustrative arrangements of nanoparticles on a surface of a substrate of a light confining structure; and

FIG. 19 schematically shows an energy storage and/or conversion system in accordance with some other alternative illustrative embodiments

### DETAILED DESCRIPTION

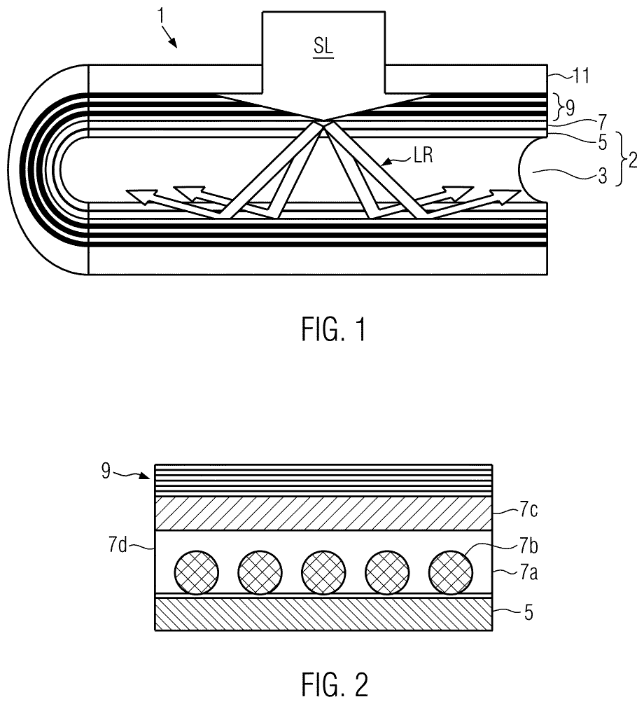

With regard to FIG. 1 and FIG. 2, optical waveguides in accordance with some illustrative embodiments will be described in greater detail. FIG. 1 schematically shows in a sectional view an optical waveguide 1 which comprises an optical fiber 2 and an optical active cladding structure which is formed over at least a portion of the optical fiber 2 at a first end of the optical waveguide 1. The first end of the optical waveguide 1 may correspond to one of the two ends of the optical fiber 2, particularly that end of the optical fiber 2 at which light is coupled into the optical fiber 2 when the optical waveguide 1 is used in applications of harvesting light. Therefore, the first end may be also considered as an “input” of the optical waveguide 1.

In accordance with some illustrative embodiments herein, the optical fiber 2 comprises a fiber core 3 and a glass or polymeric cladding 5 bordering the fiber core 3. The fiber core 3 may be an air core or a glass or polymeric core. For example, the fiber core 3 may have a diameter in the range from about 10 μm to about 1 mm. In some illustrative examples, the optical fiber 2 may have a diameter from about 20 μm to about 1.5 mm, e.g., in a range from about 300 μm to about 600 μm, such as from about 400 μm to about 500 μm. In a special illustrative example, the optical fiber 2 may have a diameter of about 469 μm without considering any (optional) protection layer (not illustrated). In some illustrative examples, the cladding 5 may have a diameter in the range from about 100 nm to about 500 μm, e.g., in a range from about 1 μm to about 100 μm such as in a range from about 50 μm to about 100 μm, such as about 86 μm.

With continued reference to FIG. 1, the optical active cladding structure comprises a Bragg mirror stacking 9 and a wavelength conversion coating 7, wherein the Bragg mirror stacking 9 is disposed over the wavelength conversion coating 7. Furthermore, the waveguide 1 may comprise a buffer coating and jacket as schematically indicated by reference numeral 11 in FIG. 1. The buffer coating and jacket may be formed of polyimide, acryl or silicone and may serve as protection against mechanical damage, as well as protection against humidity. The buffer coating and jacket is optical transparent in at least the first wavelength region such that light SL having wavelengths in at least the first wavelength region may pass through the buffer coating and jacket substantially without attenuation.

As illustrated in FIG. 1, the Bragg mirror stacking 9 may represent a dielectric mirror composed of multiple thin layers of dielectric material. In accordance with advantageous embodiments, the Bragg mirror stacking 9 is manufactured to maximize reflectivity and consists of a stack of thin layers with a high refractive index interleafed with layers of a low refractive index. The thicknesses of the layers are chosen such that path length differences for reflections from different high index layers are integer multiplies of the wavelength of which the mirror is designed. The reflections from the low index layers have exactly half a wavelength in path length difference, but there is a 180° difference in face shift at a low to high index boundary, compared to a high to low index boundary, which means that these reelections are also in phase. The Bragg mirror stacking 9 can be designed with specified reflectivity at various different wavelengths of light and, in the industry, ultra-high reflectivity mirrors with values of 99.999% or greater have been achieved over a narrow range of wavelength. For example, the Bragg mirror coating 9 represents the first lateral surface of layers 5, 7 and 9, which is to interact with irradiation as indicated in FIG. 1. For example, the Bragg mirror stacking 9 may be designed to have a high transmittance in a first wavelength region and a high reflectivity in a second wavelength region of wavelengths longer than wavelengths in the first wavelengths region.

An optical conduit which collects and transmits light, such as the waveguide 1 as described above in the context of FIG. 1, may be called “Complex Energy fiber” or “CE fiber”, names which are given by the inventor to the physical fiber of the optical conduit itself.

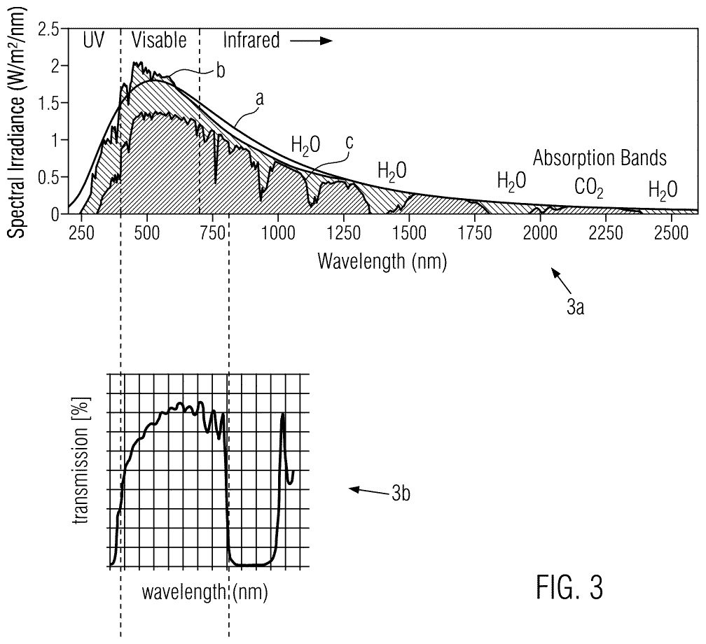

With regard to FIG. 3, an optical characteristic of the Bragg mirror stacking 9 will be described in greater detail. FIG. 3 shows a relation between transmittance and reflectivity is indicated in diagram 3b of FIG. 3 by means of an illustrative transmission-wavelength relation of the Bragg mirror stacking 9. Furthermore, diagram 3a in FIG. 3 shows a solar spectrum divided into a UV region, a region of visible light (see “visible” in diagram 3a) and an infrared region. A curve a in diagram 3a indicates the black body spectrum and curve b in diagram 3a represents the solar spectrum at the top of the atmosphere, while curve c represents the solar spectrum as measured at sea level having absorption bands for oxygen, water and carbon dioxide. As shown in diagram 3a of FIG. 3, a spectral irradiance of the solar radiation of any of curves a to c has a peak in the visible region and has a lower spectral irradiance in the UV region and infrared region when compared to the spectral irradiance in the visible region.

With continued reference to FIG. 3, a transmittance and reflectivity of the Bragg mirror coating 9 is shown in diagram 3b in accordance with some illustrative embodiments of the present disclosure. As indicated in diagram 3b, the Bragg mirror coating 9 is adjusted on the basis of the solar spectrum that the transmission is high in the region from about 380 nm to about 780 nm, and becomes low in the infrared region from about 780 nm to about 880 nm. In other words, the Bragg mirror coating 9 with the characteristics indicated in diagram 3b of FIG. 3 has a high transmittance in a wavelength region between about 380 nm and about 780 nm (particularly, a high transmittance is present in a wavelength region between about 380 nm and about 720 nm or between about 380 nm and about 700 nm), while it has a high reflectivity in a second wavelength region located between about 720 nm and about 880 nm, such as in a region between about 780 nm and about 880 nm. Accordingly, the portion of sunlight being transmitted through the Bragg mirror coating 9 is substantially given by light with wavelength in the first wavelength region. Regarding the expression “high transmittance”, this is to be understood as indicating a transmittance of at least 5%, preferably at least 10% and more preferably at least 20%, such as at least 25% or at least 30% or at least 35% or at least 40% or at least 50%. Regarding the expression “high reflectivity”, this is to be understood as indicating a reflectivity of at least 5%, preferably at least 10% and more preferably at least 20%, such as at least 25% or at least 30% or at least 35% or at least 40% or at least 50%. Additionally or alternatively, high reflectivity”, this term may be understood in relation to a transmittance of at most 50%, preferably at most 40% and more preferably at most 30%, such as at most 25% or at most 20% or at most 15% or at most 10% or at most 5%.

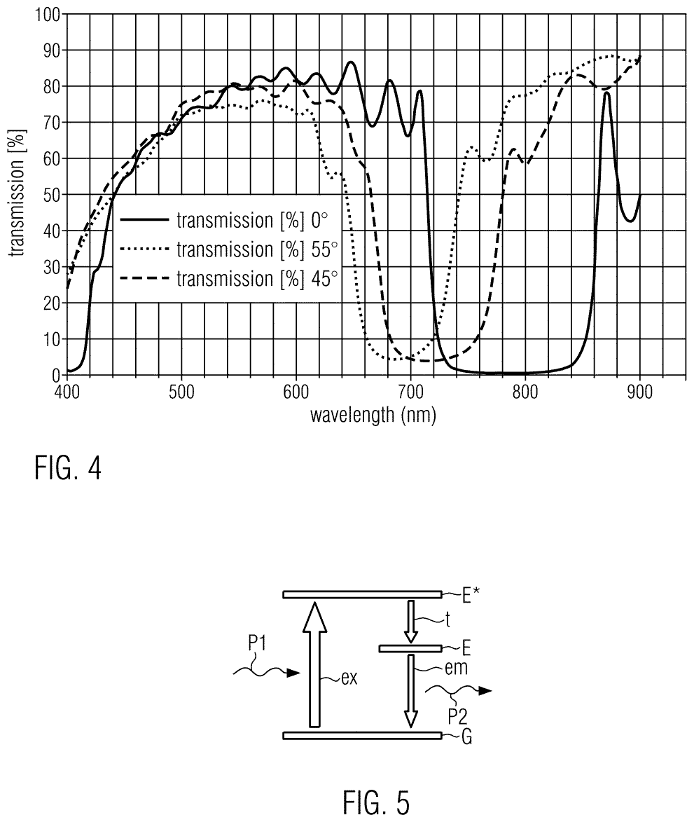

As shown in FIG. 4, the transmission characteristics of the Bragg mirror stacking 9 depends on the angle of incidence of light. FIG. 4 schematically indicates curves showing a transmission at an angle of 0° with regard to a normal of a lateral surface of the Bragg mirror stacking 9 along a direction across a length direction of a fiber, at an incidence angle of 55° with regard to a normal of the surface of the Bragg mirror stacking 9 and at an incidence angle of 45° with regard to the normal of the surface of the Bragg mirror stacking 9. Basically, a change in the incidence angle between 0° and 55° leads to a shift in the transmission region and the reflectivity region. Considering different angles of incidence of irradiation to be collected by the optical waveguide 1, an appropriate wavelength interval for the first wavelength region and the second wavelength region may be selected. For example, the buffer coating and jacket of the optical waveguide 1 may be optical transparent in only a portion of the buffer coating and jacket such that light of a certain range of incidence angles may pass through the buffer coating and jacket.

In the illustrative example shown with regard to FIG. 4, it becomes clear that, upon choosing the first wavelength region in the range from about 380 nm to about 650 nm or from about 380 nm to 720 nm, light in this wavelength region may be transmitted at a high degree of transmittance through the Bragg mirror coating, while light in the range from about 650 nm to about 880 nm or 720 nm to 880 nm is substantially reflected by the Bragg mirror coating, thereby not being able to pass through the Bragg mirror coating for light incident at an incidence angle of 0°. Preferably, light in a small wavelength region at about 720 nm shows a low transmittance and a high reflectivity for light incident at incidence angles from 0° to 55°, i.e., where portions of low transmittance for the three curves in FIG. 4 is intersected. Therefore, when selecting the second wavelength region as being given by a wavelength region from about 720 nm to about 730 nm, preferably from about 725 nm to about 730 nm, light incident at any angle from about 0° to about 55° may be reflected to a high degree (corresponding to a transmittance of at most 40%, preferably of at most 20%). Accordingly, light irradiating the wavelength conversion coating 7 in FIG. 1 substantially corresponds to light in the first wavelength region and light LR being reflected by the Bragg mirror coating 9 in FIG. 1 may be light in the second wavelength region and at a preset incidence angle.

In some alternative embodiments, an optical fiber 2 may only capture light of a single color (in an according wavelength region substantially corresponding to a single color) and, when considering a system with a plurality of optical fibers, each corresponding to the optical fiber 2, different optical fibers may be configured to capture different colors such that the system successively captures a wavelength region of harvested light corresponding to more than one color.

Referring again to FIG. 1, incident light SL transmitted through the Bragg mirror coating 9 is directed to the wavelength conversion coating 7. The wavelength conversion coating 7 is configured to convert radiation with wavelength in the first wavelength region into radiation with wavelengths in the second wavelength region, particularly converting light with wavelengths in the wavelength region transmitted through the Bragg mirror coating 9 into light with wavelength in the second wavelength region corresponding to light that is reflected by the Bragg mirror coating 9. Therefore, the light being transmitted through the Bragg mirror coating 9 and being subjected to wavelength conversion by the wavelength diversion dye coating 7 is trapped within the optical waveguide 1 in the space enclosed by the Bragg mirror stacking 9 as indicated by light LR in FIG. 1. Therefore, the light LR is propagating within the optical waveguide 1. In other words, due to the Bragg mirror coating 9, the light LR remains within the optical waveguide 1, even in case that the light LR leaves the optical fiber 2 because in this case it is reflected back by the Bragg mirror stacking 9 into the optical fiber 2.

In some illustrative embodiments herein, the wavelength conversion dye coating 7 may be provided by a wavelength diversion component such as dye, quantum dot structure, or synthetic material made from a wide range of organic polymers as a function of concentration of the fluorescent molecule such as benzoxanthene (as per known in literature). However, this is not limiting to the present disclosure and other compounds including random nanostructure compounds that harness broadband light and concentrate it into a single wavelength, for example a wavelength in the visible spectrum, is possible. Such compounds could include nanoparticles and nanorods, e.g., spheres, such nanoparticles having dimensions in the range between about 5 nm to about 100 nm.

Referring to FIG. 2, an enlarged portion of the optical waveguide 1 in FIG. 1 is schematically shown, particularly indicating features of the wavelength conversion coating 7 in greater detail in accordance with some illustrative embodiments of the present disclosure. As shown in FIG. 2, the Bragg mirror stacking 9 may be disposed directly on a wavelength conversion dye 7c that is configured to emit radiation with wavelength in the second wavelength region by stimulated emission upon being irradiated with radiation with wavelength in the first wavelength region or an additional adhesion layer (not illustrated) may be sandwiched between the Bragg mirror coating 9 and the wavelength conversion coating 7. The wavelength conversion dye 7c may convert light transmitted through the Bragg mirror stacking 9 into light of longer wavelengths which match with the region of minimum transmission in the transmission characteristics of the Bragg mirror stacking 9 as indicated in diagram 3b of FIG. 3. Therefore, the combination of the Bragg mirror stacking 9 and the wavelength conversion coating 7 sandwiched between the Bragg mirror stacking 9 and the optical fiber 2, creates a “one-way mirror” effect allowing light to enter the optical waveguide 1 through the Bragg mirror stacking 9 and, the converted portion of this light to remain trapped inside the optical waveguide 1.

In accordance with some illustrative embodiments of the present disclosure, a characteristic of the Bragg mirror stacking 9, as indicated in diagram 3b of FIG. 3, is a sharp spectral edge between high transmission and low transmission, wherein the expression “sharp edge” indicates that a change in transmission is at least 40% per 29 nm, such as at least 50% per 10 nm or 50% per 5 nm, such as 70% per 10 nm or 70% per 5 nm. This means, that an inclination of a tangent to the curve of a transmission wavelength characteristic at the sharp edge in a wavelength interval of at least 5 nm at the sharp edge may be given by these values.

In accordance with some illustrative embodiments, the Bragg mirror stacking 9 may be formed by a periodic structure which relies on a pair of mirrors with a refraction index window, where the size of the refraction index window is proportional to the efficiency of the system. Alternatively, the Bragg mirror coating may be formed by a non-periodic Bragg mirror structure, which does not depend on the refraction index window. For example, a non-periodic Bragg mirror structure may be provided by adjusting the number of dielectric layers in a Bragg mirror stacking by including more than 16 layers, such as 24, 48 or 64 layers and the like, whereas a periodic mirror is obtained in dependence on the refraction indexes of the dielectric layers in a stacking, having 16 layers or less in an illustrative periodic mirror structure.

Referring to FIG. 2, the wavelength conversion coating 7 may further comprise a nanoparticle film 7a imbedded into a matrix material 7d. For example, the nanoparticle film 7a may be formed by nanoparticle cores 7b of materials such as silver and/or gold, embedded into a matrix material 7d formed of silicon dioxide. The wavelength conversion coating 7 may be configured to enhance the fluorescence emission process of the wavelength shifting. Such a wavelength shifting may, for example and without limitation, be achieved with dyes, quantum dots, nanorods, etc.

In some illustrative embodiments, the wavelength conversion coating 7 may provide the function of random lasing and/or amplified spontaneous emission (AES). For example, random lasing and/or AES may be caused by nanoparticles of metals (such as gold and/or silver) or a 2D or 3D structure that promotes plasmon surface effects. The person skilled in the art will appreciate that such structures may be configured using a variety of materials, comprising (without limitation) at least one of nanorod metamaterials, columnar thin films with metals and/or metamaterials, graphene-based active random metamaterials, metamaterials with hyperbolic dispersion, etc. It may be possible to obtain enhanced emission by sending light through random disordered materials if the material also contains molecules that glow. The inventor consider the disorder of the structure itself as a reason for such an amplification, and see this as a tenant of chaos theory, being explained as “out of disorder comes perfect order.”

In illustrative examples, where the wavelength conversion coating 7 may comprise a nanoparticle dye layer, providing an environment for random lasing/AES, which in this case may be also called ‘nano-lasing’ because the random collection of tiny mirrors are essentially nanoparticles, e.g., at least one of gold nanoparticles, silver nanoparticles etc. Herein, randomness is due to their random orientation within the embedded dye matrix. This can be understood as light coming through and being randomly scattered from all of these nanoparticles (e.g., at least one of gold, silver, metamaterial-based nanoparticles) and constructively interfering in the regions in-between the nanoparticles, effectively amplifying the electric field in local ‘hot-spots’ all throughout wavelength conversion coating 7. The person skilled in the art will appreciate that, in plasmon-photon interactions, this electric field enhancement increases the quantum efficiency of the fluorophores close to the nanoparticles and reduces their fluorescence lifetime, resulting in a net effect of an additional increase in fluorescence intensity beyond what would exist if the nanoparticles were arranged in a very periodic pattern throughout a dye.

With regard to FIG. 2 and in accordance with illustrative embodiments, the nanoparticle film 7a may be deposited on the glass or polymeric cladding 5 of the optical fiber 2 and the matrix material 7d may function as a spacer between the nanoparticle film 7a and the wavelength conversion dye 7c. Furthermore, a surface quality of the nanoparticle film 7a relative to the wavelength conversion dye 7c may be improved by the matrix material 7d such that adhesion of the wavelength conversion dye 7c may be optimized. The nanoparticle film 7a may be used to enhance a natural brightness of the wavelength conversion dye 7c by fluorescence enhancement. In this way, an intensity of wavelength converted light as transformed by the wavelength conversion dye 7c in the wavelength conversion coating 7 may be increased by the nanoparticle film 7a. However, the person skilled in the art will appreciate, after a complete reading of the present disclosure, that the nanoparticle film 7a is only optional and, in accordance with some other illustrative embodiments, the wavelength conversion coating 7 may be only formed by the wavelength conversion dye 7c. That is, the wavelength conversion coating 7 as shown in FIG. 1 may be given directly by the wavelength conversion dye 7c shown in FIG. 2 wherein the nanoparticle film 7a and the embedding matrix 7d is omitted and the wavelength conversion dye 7c is disposed directly on the glass or polymeric cladding 5.

Reference is made to FIG. 5, which shows a scheme illustrating a function of the wavelength conversion coating 7 in FIGS. 1 and 2. In accordance with some illustrative embodiments of the optical waveguide 1 shown in FIGS. 1 and 2, the mechanism of wavelength conversion as performed by the wavelength conversion coating 7 is preferably coherent emission, such as stimulated emission or amplified stimulated emission. FIG. 5 shows a three-level system that has a ground state G, an excited state E* and a metastable state E, wherein the excited state E* is a state which decays in a fast non-radiative way.

As shown in FIG. 5, an incoming photon p1 having a wavelength in the first wavelength region lifts a state from the ground state G is to the excited state E*. Subsequently, a transmission t from the excited state E* to the state E occurs without radiation. In accordance with some illustrative examples, a lifetime of the excited state E* may be in the range of 1 to approximately 100 ns, for example in the range from about 1 to 10 ns. From the metastable state E, a transmission em into the ground state G takes place by emission of a photon p2 having a longer wavelength than the incident photon p1. However, the decay of the metastable state E is induced by another photon which stimulates the emission of the photon p2, thereby leading to a coherent emission of the photon p2. Therefore, the quantum efficiency of the wavelength conversion coating 7 being configured to emit radiation by stimulated emission, is higher than in case of spontaneous emission. Additionally, the emitted radiation is coherent.

In accordance with some illustrative embodiments of the present disclosure, the Bragg mirror stacking 9 covers the optical fiber 2 along its entire length in the optical waveguide 1. The wavelength conversion coating 7 may be only present over the optical fiber 2 at an input end of the optical waveguide 1. Furthermore, the wavelength conversion coating 7 may only partially cover a lateral surface of the optical fiber at the input end, for example, only a surface portion corresponding to light incidence under specified incidence angle on the optical waveguide 1 is irradiating the wavelength conversion coating 7.

In accordance with some illustrative embodiments of the present disclosure, the optical waveguide 1 may have a length in the range of 5 nm to about 7500 km.

Referring back to FIG. 2, a method of fabricating the wavelength conversion coating 7 and the Bragg mirror stacking 9 over the optical fiber 2 of the optical waveguide 1 is now described with regard to some illustrative embodiments.

Initially, the optical fiber 2 may be provided. The optical fiber 2 may be subjected to a step of activating the surface of the optical fiber 2 by hydrolysis. Thereafter, the activated optical fiber 2 may be subjected to a process of salinization and afterwards, gold and/or silver particles may be coupled to the surface of the optical fiber 2.

Thereafter, a matrix material may be deposited, for example, one or more silicon oxide layers may be deposited by plasma deposition for embedding the nanoparticles therein.

Thereafter, the wavelength conversion dye 7c may be deposited on the matrix material 7d, e.g. a sole gel layer or a polymer matrix including a material which is configured to perform coherent emission such as stimulated emission and/or amplified stimulated emission when converting light with wavelength in the first wavelength region into light with wavelength in the seventh wavelength region.

Finally, the Bragg mirror stacking 9 may be deposited in accordance with known techniques.

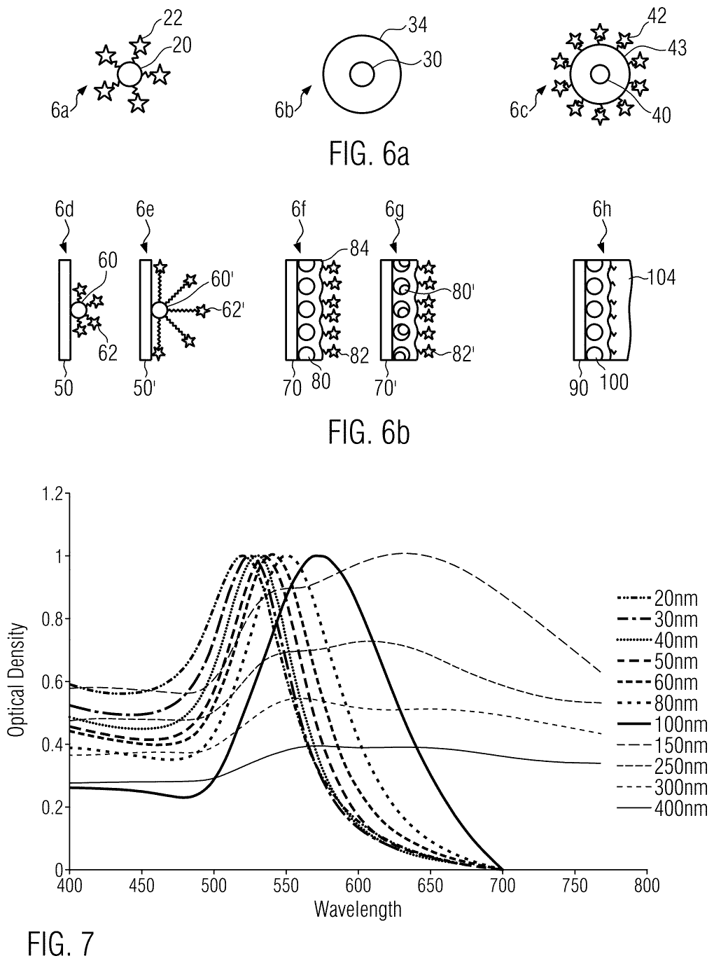

Referring to FIG. 6a, possible implementations of the wavelength conversion coating 7 in FIG. 1 are schematically illustrated and described below.

Referring to FIG. 6a, options of a realization of a dye with colloidal nanoparticles in accordance with various illustrative examples are shown. As schematically illustrated in diagram 6a, an immobilized dye 22 on a nanoparticle 20 is schematically illustrated. Diagram 6b shows an incorporated dye in a shell 34 of a nanoparticle 30, e.g. a dye incorporated in a silica shell of a gold or silver nanoparticle. Diagram 6c shows a surface-bound dye 42 on a shell 43 of a nanoparticle 40.

Below, possible examples of dyes as employed by the inventor in an illustrative example, are listed:

1) Nile red (excitation peak at 536 nm/emission peak at 638 nm)

For excitation enhancement, the dye may include nanoparticles, such as silica-coated gold nanospheres with sizes from about 50 nm to about 70 nm (having a shell in the range from about 5 nm to about 20 nm). This dye has an absorption in the range 531 nm-545 nm. In another example, nanoparticles are provided as silica-coated nanostars with a size of about 50 nm (with a shell of about 10 nm) provide an absorption at 697 nm.

2) Pyridine 2 (excitation peak at 564 nm/emission peak at 690 nm)

For excitation enhancement, the dye may include silica-coated gold nanospheres with sizes of 95/100 nm (having a shell of 5-20 nm). This dye has an absorption at 569 nm. In another example, nanoparticles with silica-coated nanostars, having a size of 50 nm (with a 10 nm shell), show an absorption at 697 nm.

The following table (TABLE 1 on the next page) summarizes dyes employed by the inventor in different illustrative embodiments, together with the characteristics of the dyes:

With regard to FIG. 6b, options of a realization of a dye with surface-bound nanoparticles in accordance with various illustrative examples are shown. Diagram 6d shows a surface-bound nanoparticle 60 with an immobilized dye 62 on a surface 50. The immobilized dye is short-bonded to the nanoparticle 60. Diagram 6e a surface-bound nanoparticle 60′ with an immobilized dye 62′ on a surface 50′. The immobilized dye 62′ is long-bonded to the nanoparticle 60′.

Referring to diagrams 6f and 6g in FIG. 6b, these diagrams show a nanoparticle 80 and 80′, respectively, bound to a surface 70 and 70′, respectively, of a substrate with a nanoparticle film layer (e.g., 84 in diagram 6f), into which the nanoparticles (e.g., nanoparticle 80 in diagram 6f) are incorporated. For example, the nanoparticle film layer (e.g., 84 in diagram 6f) may be a silica layer. On the nanoparticle film layer (e.g., 84 in diagram 6f), immobilized dyes 82 and 82′, respectively, are bonded.

TABLE 1

| | λEx | λEx | λEm | λEm | Quantum |
|---|---|---|---|---|---|
| | (lit.) | (solid) | (lit.) | (solid) | yield |
| Fluorescent dye | [nm] | [nm] | [nm] | [nm] | (lit.) [%] |
| Rhodamine 6G | 528 | 544 (Absorp- | 551 | 590 | 95 |
| | | tion max.) | | | |
| Nile red | 550 | 536 | 650 | 638 | 70 |
| Al-phthalocyanine | 604 | n.d. | 675 | n.d. | approx. 90 |
| Pyridine 2 | 532 | 564 | 718 | 690 | 19 |
| Styryl 8 | 532 | 604 | 744/764 | 752 | 15 |
| Styryl 9 | 532 | 660 | 815/839 | 822 | 10 |
| Styryl 11 | 532 | 626 | 785 | 806 | 12 |

Referring to diagram 6h in FIG. 6b, a nanoparticle film 100 is surface-bound to a substrate 90 with a nanoparticle film layer, e.g. silica layer, and a dye layer 104.

After a complete reading of the present disclosure, the person skilled in the art will appreciate that the nanoparticle film 7a in FIG. 2 together with the matrix material 7d and the wavelength conversion dye 7c, may be implemented in accordance with any of the examples as described above in the context of FIGS. 6a and 6b.

However, this is not limiting the present disclosure and, in some illustrative embodiments, NIR fluorescent materials may be employed. An example of such a dye is indocyanine green (ICG) bleach.

With respect to advantageous life times of dyes, nanomaterials may provide beneficial photophysical properties such as ultra-high photo stability and also for generating nonlinear energy transfer.

In some illustrative but non-limiting examples, NIR fluorescent nanomaterials may include InAs quantum dots, lanthanide-doped nanoparticles, or semiconducting single-walled carbon nanotubes. As examples of materials with high quantum yield, calcium copper silica materials can be applied. Known exfoliation processes such as graphene and transition metal chalcogenides can be used to produce layered structure of calcium copper silica materials, known as nanosheets, with dimensions varying from 50 nm to 5 nm diameter and height from 40 nm to 1 nm. Regarding radiative cooling frequency and because of longer wavelength fluorescence capabilities of such nanosheet structures, it is logic to conclude that waveguides can be configured to capture a vast range of electromagnetic radiation including atmospheric radiation (as back scattering from the Earth's surface at night) in the infrared range, beyond 1.5 micrometer.

In some illustrative examples, life time of a dye can be substantially extended as well as the dye's brightness while maintaining its photo stability by employing a heterocyclic compound for example an isometric chemical compound, such as as diazoles.

Referring now to FIG. 7, an optical density in relation to a wavelength is schematically illustrated for various sizes of nanoparticles. The diagram shows that nanoparticles, sized from 20 nm to approximately 100 nm, show a peak in the optical density. For example and as shown in FIG. 7, nanoparticles having sizes greater than 100 nm show no substantial peak. Accordingly, depending on the size of the nanoparticle, the position of the peak shifts from about 500 nm to about 600 nm.

The person skilled in the art will appreciate that, depending on the size of the nanoparticle, a characteristic of the wavelength conversion coating 7 in FIG. 1 may be adapted.

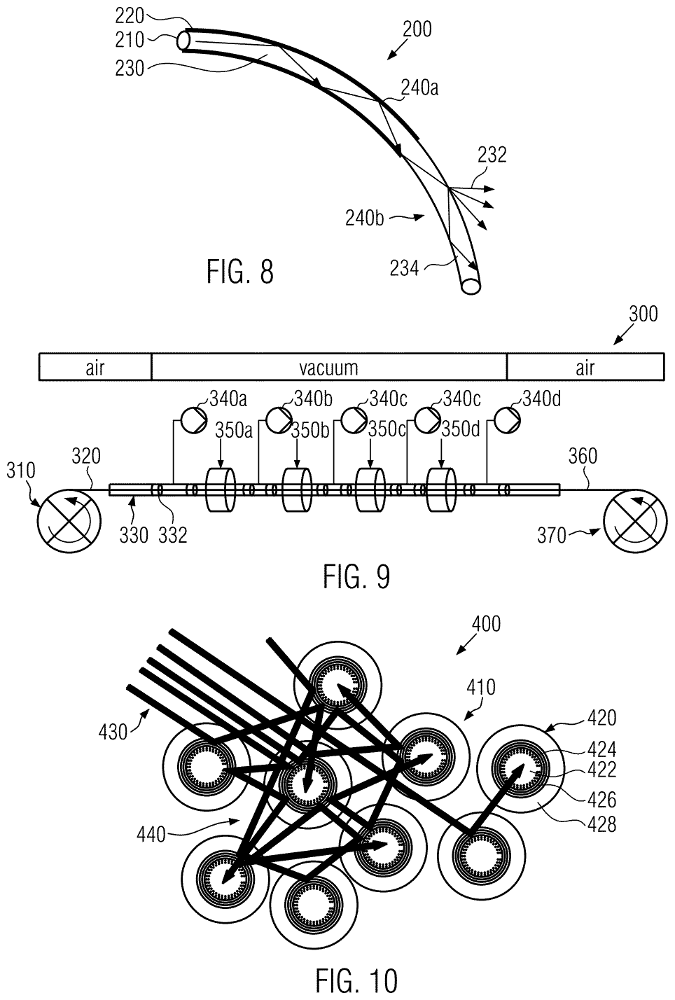

Referring to FIG. 8, the function of the Bragg mirror coating is schematically illustrated. FIG. 8 shows an optical waveguide 200 which has a Bragg mirror coating 220 on an optical fiber 210 at only a portion 240a of the optical fiber 210. A portion 240b of the optical fiber 210 is not covered by the Bragg mirror coating 220. As shown in FIG. 8, light 230 propagating inside the optical fiber 210 is captured in the optical fiber 210 due to the Bragg mirror coating 220 in the portion 240a of the optical fiber 210. Outside the portion 240a, that is in the portion 240b of the optical fiber 210, light 230 proper gating within the optical fiber 210, see light 234 in the portion 240b, has losses 232 due to light not being subjected to total reflection within the optical fiber 210 without the Bragg mirror coating 220.

Referring to FIG. 9, a fabrication of an optical waveguide with a Bragg mirror coating is schematically illustrated. FIG. 9 schematically shows a system 300 for fabricating an optical waveguide from an optical fiber 320 provided on a reel 310. The optical fiber 320 is drawn from the reel in an air environment and introduced into the fabrication system 330. The fabrication system, 330 has an input iris 332 separating the air environment from a vacuum environment. The fabrication system 330 shows four process sections 350a, 350b, 350c and 350d, which are each associated with pumps 340a to 340d and irises. At the end of the fabrication system 330, an output iris is shown, separating the vacuum environment within the fabrication system 330 from an air ambient at the output side. The fabrication system 330 is exited at the output side by a waveguide 360 which is rolled up on a reel 370.

The process section 350a is a plasma low index coating, the process section 350b is a plasma high index coating, the fabrication section 350c is a plasma low index coating and the process section 350d is a plasma high index coating. Any desired number of low/high index coating layers may be provided. Therefore, the optical waveguide 360 on the output side of the fabrication system 330, is coated by a Bragg mirror coating in a continuous way. At the input side, upon drawing the optical fiber 320 from the reel, a decladding, and a p-coating and a dye coating and/or any wavelength converter such as quantum dots is performed. At the output side, prior to rolling up the waveguide 360 on the reel 370, an optional cladding may be performed. In case that a periodic structure of Bragg mirrors is to be provided, such as for reasons of cost and/or efficiency balance, a higher number of Bragg pairs may be formed, such as 48 pairs instead of 16 pairs which would have been considered otherwise. In this way, the different (low and high index) chambers will be more flexible in regards to maintain the exact required refraction indexes.

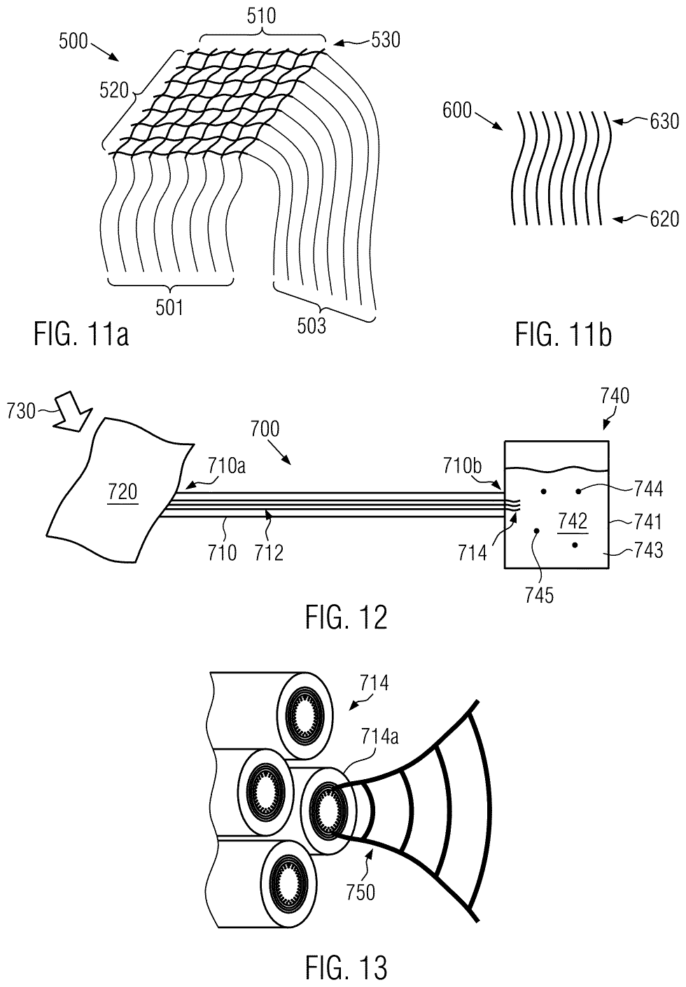

Referring to FIG. 11a, a waveguide system 500 is schematically illustrated in which a plurality of waveguides 501 and a plurality of waveguides 503 are present in an interleafed or interwoven arrangement at a first end 530 of the optical waveguide system 500. In particular, first ends 510 of the optical waveguides 501 and first ends 520 of the optical waveguides 503 are interwoven or interleafed to form an input area corresponding to the first end 530 of the waveguide system 500. That is, the first end 530 of the waveguide system 500 corresponds to an input region of the waveguide system 500. In accordance with some illustrative embodiments, the first end 530 represents an input of a light harvesting system.

Referring to FIG. 11b, an optical waveguide system 600 is schematically illustrated, where a plurality of waveguides 601 is present, the plurality of waveguides 601 having waveguides where a first end 610 of the plurality of waveguides 601 is substantially arranged in a parallel manner, for example in form of a super molecular structure as illustrated in FIG. 10. The first ends 610 provide an input region 630 which may serve as a light harvesting region in an optical waveguide system.

Referring to FIG. 12, an energy storage and/or conversion system 700 is schematically illustrated. The energy storage and/or conversion system 700 comprises an optical waveguide system 710, e.g. corresponding to one of the optical waveguide systems 400 to 600 as described above, and a container 741 storing a liquid 743. A first end 710a or the optical waveguide system 710 represents an input region 720 for harvesting light 730. The waveguide system 710 further comprises a plurality of optical waveguides 712 which extends between the first end 710a and a second end 710b of the optical waveguide system 710. At the second end 710b of the optical waveguide system 710 opposite the first end 710a, the optical waveguide system 710 is arranged so as to direct radiation emitted from fiber ends 714 of the optical waveguide system 710 into the liquid 743 stored in the container 741. The liquid 743 in the container 741 comprises highly conductive composites 744 and graphite 745 which are immersed in the liquid 743. Alternatively, light harvesting may take place along the entire length of the optical waveguide system 710.

In accordance with some illustrative embodiments of the present disclosure, the highly conductive composite 744 may be made of phase change materials, such as nitride salt mixture. Additionally, the liquid 743 may further comprise metal nanoparticles such as gold and/or silver cores immersed therein. In some illustrative examples herein, the nanoparticles may be configured in a disordered arrangement as a complex porous structure with a random network of pores. Such nanoparticles may be embedded in amorphous silicon to allow nanoparticles to heat high temperatures (like 500-700° C.) while in the container 741. The morphological changes of the core, while submitted to intense temperatures, can possibility even enhance the thermal storage capabilities promoted by Anderson localization. It is noted that disordered nanoparticles present almost an ideal black-body performance in which broadband light is “condensated” or condensed. The engineering of such NPs may be very versatile and the NPs can easily be dispersed in the liquid of the tank 741, where they can be floating or embedded in a random arrangement that holds them together, depending on each application (implying the integral energy arriving in the tank 741 which will lead to the liquid temperature. The conversion of light to thermal energy may then take place from light captured in the nano absorbers to the liquid. The density (possibly around a unit concentration of 3×10¹⁰ cm⁻³) of the material immersion into the liquid then characterizes the overall absorption efficiency. Accordingly, densities are easily tunable depending on each application, which determines the overall thermal energy in the tank. This density can be as flexible as five to ten times the unit concentration mentioned. These nanoparticles can also be configured in a stand-alone structure, such as the structure store optical energy to be then later converted to thermal energy once in contact or in optical proximity with water/liquid.

In accordance with some illustrative embodiments of the present disclosure, the liquid 743 may be water. Alternatively, the liquid 743 may be a liquid having a thermal capacity which is equal to or smaller than the thermal capacity of water. For example, salt melts at 131° C. and is kept as liquid at 288° C. With integral energy coming from a transmission mesh depending on the application/configuration/area of the transmission structure, the overall energy arriving in the container 741 can heat up the liquid salt to temperatures around or beyond 500° C. With proper insulation in the container 741 (like the examples given above with regard to the container 741, such as refractory bricks) it is estimated that the thermal energy may be stored for a week. In another example, solid or molten silicon, reaching higher storage temperatures of about 1400° C., or molten aluminum, reaching temperatures around 600° C., may be employed. Still other possibilities include a mix of alloys, for example a miscibility gap technique that could or not be related to a metallic material for thermal energy storage. A container-distributed configuration can be applied whenever the incoming energy is too high leading to beyond 1500° C. for example.

With regard to FIG. 10, a waveguide system 400 is schematically illustrated. The waveguide system 400 comprises a plurality of optical waveguides 410, e.g. an optical waveguide 420 having an optical fiber 422, a wavelength conversion coating 424, a Bragg mirror stacking 426 and a cladding 428. The cladding 428 may be transparent to light of wavelength in the first wavelength region. Incident light 430 is indicated as a bundle of light rays that are incident on the plurality of optical waveguides 410. For example, the light 430 may be incident extensively all along the fiber's 422 extension for realizing a 3D side-coupling. The structure shown in FIG. 13 may be a “super molecular structure”, that is a disordered geometry, in which light rays not directly entering an optical waveguide propagate through the plurality of optical waveguides 410 in random walk until being trapped within an optical waveguide, e.g. see light ray trapped in optical waveguide 420.

Referring to FIG. 13, fiber ends 714 of the plurality of waveguides 712 of the super molecular structure of FIG. 10 are shown, the ends 714 being arranged with regard to the liquid 743 in FIG. 12 in the container 741 of FIG. 12 such that radiation output by the plurality of optical waveguides 712 is directed into the liquid 743. An output radiation is schematically indicated in FIG. 13 by reference numeral 750. Due to the presence of the composites 744, graphite 745 and, optionally, metal nanoparticles such as gold and/or silver cores, in the liquid 743, the output radiation 750 is absorbed in the container 741. Upon absorbing the output radiation in the container 741, the liquid 743 is heated up. Accordingly, photonic energy provided by the radiation 730 harvested at the first end 710a of the energy storage and/or conversion system 700 in FIG. 12 is transmitted by the optical waveguide system 710 to the container 741 at the second end 710b, where it is absorbed and used for heating the liquid 743 in the container 741. Therefore, an efficient energy storage and/or conversion system for converting heat is provided by the energy storage and/or conversion system 700.

Although fiber ends 714 in FIG. 12 are illustrated as being located within the container 741, this does not pose any limitation on the present disclosure. Alternatively, the fiber ends 714 may be arranged with regard to the container 741 and the liquid 742 in FIG. 12 in a way that radiation emitted from the fiber ends 714 is coupled into the liquid 742. The person skilled in the art will appreciate that appropriate measures will be implemented for reducing loss of radiation when coupling light emitted from the fiber ends 714 into the liquid 742.

In accordance with illustrative examples in which the fiber ends 714 are located within the container 741, inner surfaces of the container 741 may be coated with a highly reflective surface in order to increase efficiency of the energy storage and/or conversion system 700. Additionally or alternatively, the container 741 may be isolated against heat dissipation towards an environment of the container 741. Accordingly, heat loss of the energy storage and/or conversion system 700 may be reduced by employing appropriate materials as discussed above, for example.

In accordance with some illustrative embodiments, some fibers 712 of the optical waveguide system 710 may be used for transporting optical data. For example, these fibers 712 used as data fibers may comprise data terminals (not illustrated) which may be connected with a data system (not illustrated). In this case, the data fibers of the fibers 712 do not have fiber ends 714 located within the container 741, but are routed outside of the container 741 to a data system (not illustrated).

Regarding the energy conversion system as described above with FIGS. 12 to 13, effects and advantageous will be described in a general context below.

Initially, it is recalled that previous research has confined light for finite periods of time using mirrors and specially engineered materials, but confining light indefinitely, remains conceptually unproved to date. It has been theoretically conceived that light can be confined temporally using surface plasmonics via metal-based configurations that increase absorption and that couple with thermal conversion more efficiently.

The present disclosure relates to an energy storage and conversion system which provides, in some illustrative embodiments, a light confining structure that relies on a disordered geometry structure that could use low-power metal or high-power non-metal materials. Confinement of light is achieved because photons travel in circles and not absorbed within these nanostructured geometries light with precise energy values are confined for an infinite amount of time. To avoid losing trapped light due to absorption on material imperfection, these imperfections are structured on a way so that a scattering chaotic geometry as if compensated in an optical gain similar to lasers so that in principle the lifetime could be infinitely large.

In some illustrative embodiments, transparent structures with non-Euclidean geometries (such as Riemannian manifolds) can be used for confining light by scattering in a very specific way which can be understood when taking the theory behind Bose-Einstein condensation into account, so that light reaches a specific quantized energy value. In this regard, only when an electron reaches a quantized energy level it is “allowed” by an atom to occupy a spin or angular momentum in an analogy. Under a specific disordered non-Euclidean geometry radiation loss is suppressed, avoiding time decay of a natural oscillation of the system. Because of the energy equipartition of such nonlinear geometries non-metal materials such as glasses can be used, thus opening space for substantially high-power harness from electromagnetic radiation. Once confined light is specifically quantized and “squeezed” within a narrow wavelength, to release it an external optical signal is radiated onto the structure with a function of colliding and mixing with the trapped light so the light would be de-condensed (or de-quantized), similar as if an electron loses its electromagnetic pull while in orbit within an atom. In this sense, the stored optical energy can be released at any moment when a demand of energy is required by any system connected to the OES, such as a Photovoltaic cell, a solar thermodynamic tank, or artificial photosynthesis systems for production of solar fuels such as hydrogen, ethanol, etc. Such structure may be fabricated by known techniques, such as lithography, colloidal synthesis procedures, wet-chemistry techniques, etc.

In some special illustrative embodiments, the light confining structure is embodied on the basis of a mechanism motivated by Bose-Einstein condensation. As the starting point of this concept, the inventor identified geometrical disorder and wave disorder (e.g., quantum chaotic structures). The inventor found that such a system can increase the coherence of single light emission through a process completely equivalent to Bose-Einstein condensation in the sense of quantized energy equipartition, and can induce maximum localization effects (light wavelength squeeze until it self-organizes around a critical value), whereas such a system is unrelated to plasmonic resonance light confining structure.

Bose-Einstein condensation of photons at room temperature is very unstable. The inventor suggest achieving a stabilization in a feasible implementation by a combination of Bose-Einstein condensation of photons with Anderson Localization or Amplified Spontaneous Emissions within a specific shell-core configuration similar to an optical resonator with layers of a chaotic pattern on the exterior surface of both shell and core. The inventor point out that, when bosons such as photons are placed inside a cavity, they interact with fermions in the encircling matter, such as glass (for example silicon dioxide), and upon introducing a chaotic layer onto a material structure having nonlinear permittivity, energy radiation loss inside the nucleus may be compensated. Accordingly, light scattering occurs once electromagnetic radiation impinges onto a nonlinear material and light confinement is achieved once light is squeezed into a specific wavelength into the core's walls, wherein a plasmonic optical gain compensates for losses in the material's disordered structure. Herein, the inventor acknowledged that a system with sufficiently large disorder exhibits properties like absence of diffusion and that light localization takes place on atoms in BEC of atoms. In other words, it is proposed to combine a light state into a disordered cavity (localization) so as to achieve Bose-Einstein condensation of atoms and it is desired to encounter Bose-Einstein condensation (slowing down of light) and light localization notably while light stays confined in the cavity. The critical wavelength of light in the core is to be determined by the amount of energy stored depending on each application. The level of disorder is then the parameter that will determine the phase transition temperature, so that photons can be confined in cavities at room temperature, thus leading to photons circulating inside the resonator, notably around the core, leading to optical storage. In other words, changing the turbulence level in a chaotic cavity, photonic energy reaches a phase transition critical temperature leading to light condensation at ambient temperatures.

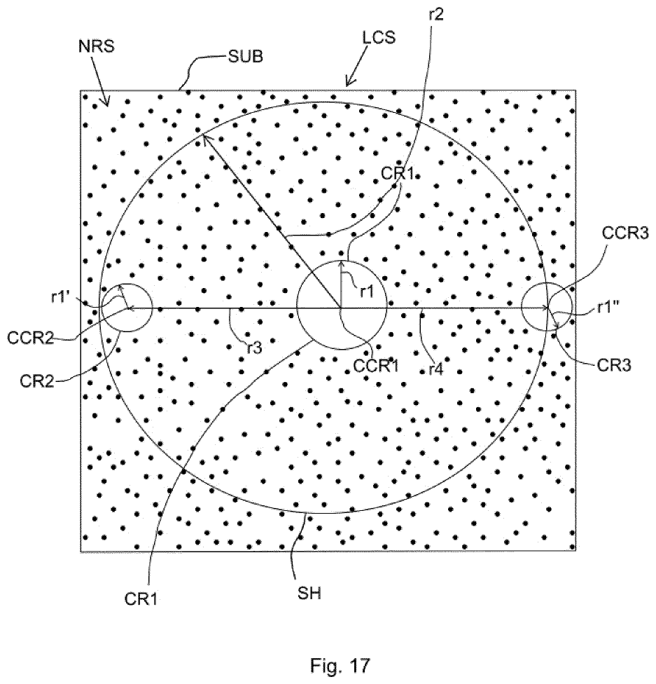

In some illustrative embodiments herein, a light confining structure that relies on a disordered geometry structure is provided. Referring not to FIG. 17, a schematic top view onto an enlarged portion of a light confining structure LCS is schematically depicted. The light confining structure LCS comprises a substrate and a micro- or nanostructure.

As shown FIG. 17, the light confining structure further comprises a nanophotonic resonator structure NRS provided in or on the surface of the substrate SUB provided as a disordered nanophotonic resonator structure configured with a proper level of disorder. Herein, a proper level of disorder in the nanophotonic resonator structure is formed by a high density of nanophotonic resonators with a certain degree of disorder in the density of nanophotonic resonators as they are distributed over the surface of the substrate SUB. Herein, disorder in the density of nanophotonic resonators is understood as being characterized by this density following a distribution around a mean value with a minimum variance greater zero indicating deviations from an ideal homogeneous distribution of nanophotonic resonators which is considered as having zero variance. Accordingly, disorder is for example illustrated in this context in the sense that a density of nanophotonic resonators varies across the surface of the substrate SUB with a minimum variance around a mean value taken across the surface of the substrate SUB. It is assumed that a homogeneous distribution results in a scale invariant density of nanophotonic resonators in the sense that, upon virtually partitioning the surface of the substrate SUB into a regular grid of area boxes, a density of nanophotonic resonators calculated in for each area box results in a single value that remains constant upon scaling the regular grid of area boxes to differently sized area boxes. By contrast, disordered nanophotonic resonators show a scale and position dependent density. The position dependent density at a certain scale of the virtual grid may be evaluated by averaging over the area boxes for obtaining a mean density value with a variance given by a squared mean value of deviations of the density in the area boxes from the mean density value. Upon this variance being greater zero, a disordered distribution of nanophotonic resonators is present across the surface of the substrate SUB. An illustrative scaling at which the disorder of the nanophotonic resonators may be evaluated, may be a scaling at which each area box contains a single micro- or nanoparticle resonator formed of a single shell nanoparticle which is referred to as a unit area box. However, this is only illustrative and not limiting and another scaling may be chosen instead, such as a scaling at which each area box contains ten micro- or nanoparticle resonators, i.e., ten shell nanoparticles, or hundred micro- or nanoparticle resonators, i.e., hundred single shell nanoparticles, or one thousand micro- or nanoparticle resonators, i.e., one thousand shell nanoparticles, etc. It is also possible to select a scaling according to which an area box is dimensioned so as to cover a fraction of the unit area box, e.g., one half, one third, one forth etc., generally 1/n with n being a natural number greater one. In general, any number of micro- or nanoparticle resonators, i.e., shell nanoparticles, may be chosen depending on a desired accuracy in the evaluation of the degree of disorder and an available resources necessary for determining the required parameters.

In accordance with some illustrative embodiments herein, the density of nanophotonic resonators may be evaluated in accordance with a filling fraction representing a fraction of space in the surface of the substrate SUB being filled with nanophotonic resonators. For example, the filling fraction may represent a fraction of total area consumed in the surface of the substrate SUB by the nanophotonic resonators divided by the total surface area of the surface of the substrate SUB. In some illustrative examples herein, the inventor identified a filling fraction in the range from about 50% to about 85% with a variance of at least 5% as giving a proper degree of disorder in the nanophotonic resonators, where a filling fraction of more than 85% is expected to result in a saturation effect known as random parking. According to preferred examples herein, the variance of the filling fraction may be in the range from about 5% to about 20%, more preferably in the range from about 5% to about 10%, such as at about 7%, while the filling fraction is preferably in a range from about 60% to about 80% or 60% to about 75%, more preferably in a range from about 60% to about 75%, such as at about 68%.

In some illustrative embodiments herein, the nanophotonic resonator structure NRS may be formed as a structure of nanophotonic cavities provided by quantum dots formed on the surface of the substrate SUB. According to illustrative examples herein, quantum dots may be formed in a homogeneous manner but with a high density across the surface of the substrate SUB and cavities within the quantum dots are formed in a disordered manner in compliance with a desired degree of disorder as described above. For example, quantum dots, e.g., quantum dots made of InAs, may be adhered to the surface of the substrate SUB via an adhesion layer, e.g., a layer of polyimide. In some examples, quantum dots are formed on the surface of the substrate SUB via molecular beam epitaxy, e.g., on a silicon oxide base substrate, e.g., silicon dioxide, or a GaAs substrate and the like. In particular, the high density of homogeneously distributed quantum dots is to be greater than a targeted density of nanophotonic resonators, such as a filling factor of homogeneously distributed quantum dots is to be greater than a filling factor of the nanophotonic resonators as described above. According to some illustrative examples, quantum dots may be formed via electron beam lithography techniques in a homogeneous or inhomogeneous manner and cavities in the quantum dots may be formed with ion beam etching, reactive ion etching and the like.

In some other illustrative examples herein, the nanophotonic resonator structure NRS may be formed as a structure of nanodimensioned holes formed in the surface of the substrate SUB. The holes may be formed by ion beam etching or RIE etching or plasma etching.

In accordance with illustrative embodiments, the micro- or nanostructure comprises micro- or nanoparticle resonators formed of core-shell nanoparticle structures with specific permittivity and being deposited on a surface of the substrate SUB. The micro- or nanoparticle resonators function as open resonators where a shell SH of low permittivity is formed on the surface of the substrate SUB and encloses at least two cores, where FIG. 17 shows an illustrative but non-limiting example in which cores CR1, CR2 and CR3 are enclosed within the shell SH. The shell SH has a low permittivity which leads to oscillations with theoretically infinite long times, wherein low permittivity is to be understood as being given by a relative permittivity of smaller one, such as smaller 0.5 or smaller 0.2 or smaller 0.1 or smaller 0.05.

In accordance with illustrative examples herein, the shell SH may be provided by a shell of a micro- or nanoparticle and each core CR1, CR2, CR3 may be provided by a core of a micro- or nanoparticle. In some illustrative examples, the micro- or nanoparticle structure may be formed of a mixture of micro- or nanoparticles of different types such as a transparent spherical core-shell micro- or nanoparticle structure including cores in form of micro- or nanospheres, micro- or nanorods, nanowires, nanotubes and the like, while the shell is provided as a micro- or nanosphere or a micro- or nanoellipsoid.

Referring to FIG. 17, the core CR1 may be spherical and have a radius R1, core CR2 may be spherical or rod-shaped and have a radius r1′, and core CR3 may be spherical or rod-shaped and have a radius r1″. The shell SH may have a diameter (or minimum dimension in case of a shape differing from a spherical shape) determined by a radius r2. Accordingly, a first geometric constraint on the dimensions is as follows: r2>r1, r1′, r1″. The core CR1 is spaced apparat from CR2 via a center spacing taken from a center CCR1 of core CR1 and a center CCR2 of core CR2 by a distance r3 and the core CR1 is spaced apparat from CR3 via a center spacing taken from the center CCR1 of core CR1 and a center CCR3 of core CR3 by a distance r4. Accordingly, second geometric constraints on the dimensions are as follows: r2>r3, r4 and 2*r2≥r3+r4. It is understood that light is confined into a wavelength around the diameter of the open resonator, always considering that for micro- or nanoparticle structures, the radius r2 of the shell SH is greater than the radius of each core CR1, CR2, CR3. Furthermore, it is understood that the structure and materials of micro- or nanoparticles in the micro- or nanoparticle structure are selected so as to avoid transmission, absorption and scattering of light in all directions unless the scattered light “condensate” (Bose-Einstein condensation) via “spontaneous emission and/or localization” (Anderson Location) at room temperature. The explicitly described examples above are not limiting and the skilled person will appreciate that any configuration may depend in general on considerations, such as the total amount of optical energy to be stored etc.

In some special illustrative embodiments, the micro- or nanoparticle structure may be of the order of tens to hundreds of nanometers in size, thereby providing a nanophotonic core-shell nanoparticle resonator (NPCSR). However, this is not limiting the present disclosure and the micro- or nanoparticle structure may be of the order of micrometers.

According to some special illustrative examples herein, a nonlinear core of an elliptical shape may be employed, allowing to reduce radiation loss.

In some illustrative embodiments, the outer shell may be made of a material with low permittivity. For example, materials with epsilon near zero lead to desired and improved performances. However, this does not limit the present disclosure and any dielectric materials may be used. In a preferred embodiment, the outer shell permittivity tends towards zero in the squeezed frequency domain.

In some illustrative embodiments, the core may be made of dielectric materials, such as porcelain, mica, and quartz, or organic materials such as organic polymers may be used as dielectric materials.

In some illustrative embodiments, the shell may be made of plasmonic materials, such as metallic or non-metallic materials. If metallic materials are used, then high energy storage metamaterials as known in the art are preferred.

In accordance with some illustrative embodiments, resonators may be fabricated in total analogy to fabrication as known as nanolithography, such as discussed in Liu et al (“Fabrication of Si/Au Core/Shell Nanoplasmonic Structures with Ultrasensitive Surface-Enhanced Raman Scattering for Monolayer Molecule Detection”, J. Phys. Chem. C 2015, 119, 2, 1234-1246) and Susarrey-Arce et al (“A nanofabricated plasmonic core-shell-nanoparticle library”, NanoScale Journal, issue 44, 2019.), the disclosure of which is incorporated by reference in its entirety.

In the nanoparticle structure according to the present disclosure, a chaotic structure is created on a surface layer of a micro- or nanoparticle during fabrication of the light confining structure. In order to reach condensation and localization, the inventor found that three key parameters are to be considered when creating the needed chaotic structure on the surface of core and shell.

The number of holes need to obey a density assumption according to which a stronger Bose-Einstein condensation is achieved with increasing number of holes, while a low critical temperature that would inhibit BEC condensation to take place, is avoided. However, a high hole density could lead to saturation, an effect known as random parking. In some illustrative embodiments herein, a suitable parameter for quantifying this aspect is scale void filling fraction (1st parameter).

The inventor found out that localization supports stability of Bose-Einstein condensation which stably happens if a proper level of disorder is configured. In some illustrative examples herein, a typical core diameter may be 244 nm±51 nm, a shell may be greater than 295 nm±51 nm, and a nearest neighbor separation of 580 nm±120 nm. For example, the mean scale void filling fraction may be about 68%±7%. In some illustrative embodiments herein, suitable parameters for quantifying these aspects may be scattering center diameter (2nd parameter) and scattering center spacing (3rd parameter).

In special illustrative embodiments and as described above, the scale void filling fraction (1st parameter) may be in a range from about 50% to 85%, e.g., at 68%, the scattering center diameter (2nd parameter) may be in the range of 200-400 nm or 240-400 nm or 200-350 nm or 240-350 nm, and the scattering center spacing (3rd parameter) may be in a range of 460-700 nm or 500-700 nm or 460-600 nm or 500-600 nm.

In special illustrative embodiments and as described above, the scattering center diameter (2nd parameter) may have a variance in a range from about 10% to about 40%. For example, the variance may be in a range from about 10% to about 30% or in a range from about 15% to about 25%, e.g., 20% or 20.9%.

In special illustrative embodiments and as described above, the scattering center spacing (3rd parameter) may have a variance in a range from about 10% to about 40%. For example, the variance may be in a range from about 10% to about 35% or in a range from about 15% to about 25%, e.g., 20% or 20.7%.

In some illustrative examples and as discussed above, holes can be made of quantum dots, such as InAs quantum dots on a GaAs planar dielectric. The inventor acknowledge that disordered photonic materials can diffuse and localize light through random multiple scattering. Light transport in such media is governed by photonic modes characterized by resonances with finite spectral width and spatial extent, the transport being controlled using wavefront shaping techniques by shaping the incident wave to excite only a specific part of the modes available in a given system, for example. Herein, individual modes are selectively engineered. Control over light. For example, confinement and mutual interaction of modes in a two-dimensional disordered photonic structure may be engineered, where strong light confinement may be achieved at fabrication stage by optimizing the structure, and an accurate and local tuning of mode resonance frequencies may be achieved via post-fabrication processes.

In some special illustrative embodiments herein, a disordered photonic system may be realized on a GaAs planar dielectric waveguide with a thickness of 100 nm to about 1 μm, e.g., at 320 nm, suspended in air and clamped at its edges resulting in a square pad with lateral size in an range from about 1 μm to about 1 mm, e.g., at about 25 μm. This planar waveguide may be optically activated by inclusion of three layers of high-density InAs quantum-dots, e.g. grown by molecular beam epitaxy. These quantum dots may be buried in a middle plane of the slab, homogeneously distributed all over the sample and emit in a broad range of wavelengths, e.g., from 1.15 μm to 1.38 μm. The homogeneous and high-density distribution of quantum dots (approximately 103 μm²) leads to bright spots in the intensity maps in correspondence to underlying localized modes generated by multiple light scattering without being caused by fluctuations in the density of quantum dots. The waveguide may be patterned with a random distribution of cavities, e.g., circular holes, by electron-beam lithography, reactive ion etching (RIE) and wet etching. In some illustrative examples, the random distribution of cavities may have a density ranging with a filling fraction f from f=0.13 to f=0.35 (herein, the filling fraction may be defined as a ratio between an area occupied by scatterers and the total area of a sample) and diameters ranging from about 100 nm to about 500 nm, such as in the range from about 180 nm to 250 nm. Deviations of any structural parameter from a nominal value can be measured with a scanning electron microscope and acceptable deviations may be within 5% for diameters and 10% for the filling fraction. Merging of adjacent cavities during growth process (proximity effects) may be avoided by imposing a minimum distance between centers of the nearest neighboring cavities of about 1 to 2 times the diameter of cavities, e.g., about 1.3 times the cavity diameter.

In some illustrative embodiments, the above described fabrication of the disordered photonic system realized on a GaAs planar dielectric waveguide may be applied to a 3D chaotic structure via known in the art methods, such as nanosphere lithography (NSL). Through NSL, single-layer hexagonally close packed or similar patterns may be applied directly on surfaces of micro- or nanoparticles, e.g., first the core than the shell. The outer layers may apply planar ordered arrays of latex or silica spheres as lithography masks to fabricate nanoparticle arrays.

In same special illustrative example herein, a nanosphere lithography method for patterning and generation of semiconductor nanostructures at low costs is described as an alternative to conventional top-down fabrication techniques. Herein, a plurality of silicon pillars of sub-500 nm diameter and with an aspect ratio up to 10 covering a surface of a base substrate may be fabricated using a combination of nanoparticle lithography, e.g., nanosphere lithography, and deep reactive ion etching techniques. In the process, a base substrate, e.g., a silicon substrate, is coated with a nanoparticle etch mask, such as a nanosphere etch mask in a special illustrative example herein, and etched using oxygen plasma and a time-multiplexed “Bosch” process, thereby producing nanopillars of different length, diameter and separation. As can be confirmed by scanning electron microscopy data, etch rates of the base substrate with the nanoscale etch masks decrease linearly with increasing aspect ratio of the resulting etch structures. Size and separation of the nanopillars may be controlled by using polystyrene nanospheres of different sizes and etching these spheres with oxygen plasma to tailor the diameter of the nanosphere lithography mask. Since these masks may be densely packed with separation at the nanoscale, their packing density drastically affects the flow of reactive ion etchants and effluent ion species during the etching process. In this way it may be seen that the etch rate of the base substrate is controlled by the separation of etched “resists” and the etch time. It can be confirmed by scanning electron microscopy (SEM) that etch rates of the masked base substrate decrease linearly with increasing aspect ratio of the resulting etched structures. Accordingly, monolayers of nanospheres to be used as lithography masks can be created using multiple methods.

In addition to the discussion of disorder above, it is noted that fabrication of disorder per se can be optimized. The person skilled in the art will appreciate that techniques to tailor a certain degree of disorder can be applied in analogy with the discussion in Rothammer et al (“Tailored Disorder in Photonics: Learning from Nature.” Advanced Optical Materials, 2021), the disclosure of which is incorporated by reference in its entirety.

In accordance with some illustrative embodiments, the chaotically micro or nanostructured nanoparticles, e.g., chaotically micro or nanostructured spheres, then will be dispersed and packed together on the substrate surface of any non-absorbing material that will hold together all the nanoparticles once the spheres are stabilized. In some illustrative examples herein, the nanoparticles can be fabricated with a larger diameter even up to the scale of micrometers depending on the amount of incoming optical energy. The substrate serving as a final supporting structure can be a rigid or flexible membrane or film that will be facing the incoming radiation that it is to be optically stored. While packing the nanoparticles, e.g., spheres, together, a preferred packaging may be the hexagon packaging which is the densest packaging arranged in a hexagonal lattice, resulting in a maximum efficiency such as to avoid voids in between nanoparticles.

In accordance with some illustrative embodiments herein, the micro- or nanoparticles can be provided on the surface of the substrate using a number of methods such as: atomizer, atomizer, printing, patterning, mechanical-based dispense evaporation, spin coating, as well as electric deposition/plating, selective electrospray via masking or programing, self-assembly, incubation, etc.

In some special illustrative examples herein, geometric disorder may be implemented in the light confining structure by a random distribution of index of refraction wave disorder in or on the surface of the substrate SUB in FIG. 17. The net effect of disorder is to create a source of random coupling among the different modes of transported light. The effect of the light confinement structure LCS in FIG. 17 is that, while incoming electromagnetic radiation introduces new photons in the volume, light-matter processes of spontaneous and stimulated emission alter their distributions by for example diminishing the number of photons at some frequency and increasing photons at other wavelengths. Accordingly, any optical gain medium, dye, Raman amplifier, or a semiconductor nanostructure like quantum dots (represented in the embodiment-drawing) may be used in the light confinement structure LCS.

With regard to embodiments employing quantum dots, it is noted that quantum dots in the strong confinement regime have an emission wavelength that is a pronounced function of size, adding the advantage of continuous spectral tunability over a wide energy range simply by changing the size of the dots. In some illustrative embodiments, quantum dots may have relatively large lateral sizes of at least 10 nm, such as about 20 nm. For example, quantum dots may be prepared as a colloidal quantum dot structure applied to the surface of the substrate SUB.

In accordance with some illustrative embodiments, the cores CR1, CR2, CR3 may be provided by nanospheres which may be prepared with irregular shape and/or disordered arrangement. For example, a lithographic fabrication of nanospheres on the surface of the substrate SUB may induce enough disorder due to a small nanoscale of these nanospheres. In illustrative examples herein, nanospheres may have diameters of about 40 nm such that r1, r1′, r1″ may be about 20 nm.

As per the preceding discussion of confinement of light, several different configurations, geometries and architectures can be designed obeying the principle, varying per application depending on the amount of EM power to be stored. For example, spherical or icosahedral can be considered, although icosahedral geometries may be more scalable than spherical for example.

In another illustrative embodiment, a metallic and/or non-metallic cavity can be used within a random network of pores as nanophotonic resonators, each comprising an infinitely long waveguide. An advantageous system for highly efficient scattering may be reached by a compromise between two competing effects, namely a suitably large pore size and a suitably large number density of pores.

With regard to some illustrative embodiments and as discussed above with regard to FIG. 17, a nanostructure can be composed of filaments acting as shells for deformed spheres as cores. For example, a random network of filaments may be provided by the following parameters: filament diameter=244 nm±50 nm, nearest neighbor separation of 580 nm±120 nm, and a mean scale void filling fraction of about 68%±7%

An illustrative design for a complex light confinement structure may comprise a final integrated structure, where the nano structure geometry within the same geometry on a macro scale obeys the same parameters discussed above in the preceding paragraph. An allusion here may be, for example, a Sierpinski geometry.

In some illustrative examples, microstructures and/or nanostructures within a complex light confinement structure may be deposited by Plasma deposition process.

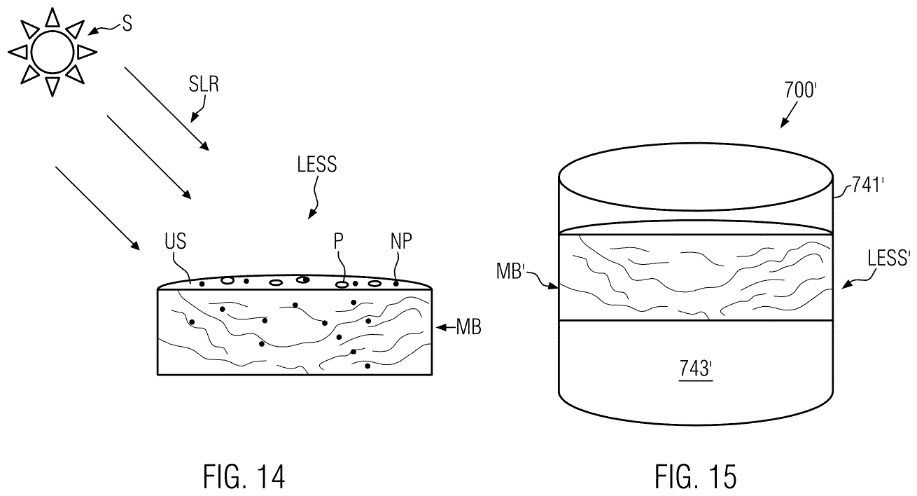

With regard to FIG. 14, a light energy storage structure LESS in accordance with some illustrative embodiments is shown. The light energy storage structure LESS comprises a porous membrane body MB with a plurality of pores P. The membrane body MB may further comprise a disordered network of channels, each of which at least partially extending through the porous membrane body MB such that at least some of the pores P formed in a surface, e.g., an upper surface US of the porous membrane body MB, may be in communication with at least one channel extending within the porous membrane body MB. The membrane body MB may be provided in a cylindrical shape or any other desired and/or appropriate shape.

In accordance with some illustrative embodiments, the membrane body MB may have a geometry of porous medium provided by pore bodies and pore throats of different sizes. This geometry may further encompass a topology given by the connection of pore bodies and pore throats to each other. It is noted that the pore morphology affects network topology and discretization. It may be advantageous to create multiple network structures the same material when providing different membrane bodies MB.

A parameter for characterizing the membrane body MB may be porosity (which is understood as being given by porosity=(Volume of Voids/Total Volume)×100%). Accordingly, a membrane body with increased porosity may be obtained by increasing the volume of voids in the membrane body MB.

In accordance with some illustrative embodiments of the present disclosure, the porosity of materials used for providing the membrane bodies may be modified based on the assumption of a linear dependency between the porosity (P) and the square of the refractive index (i.e. the relative permittivity E) of the material. This is, however, not limiting to the present disclosure and a quadratic or general dependency based on an arbitrary mathematical function, e.g., by a power series, may be assumed.

As an illustrative but non-limiting example, a membrane body MB formed of TiO₂ is provided. In an illustrative but non-limiting example, modified TiO₂ may be provided by a mesoporous TiO₂ (mp-TiO2) layer formed by spin-coating (e.g., 4000 rpm, 30 s or 3000 rpm to 5000 rpm and 10 s to 50 s) using a paste of TiO₂ composed of TiO₂ nanoparticles having diameters in a range of about 5 nm to about 100 nm, such as about 20 nm to about 50 nm, preferably about 25 nm or about 40 nm, that was diluted in 1-butanol (paste to solvent ratios of 1:4 or 1:6, for example). Subsequently, the spin-coated material may be annealed at temperatures of about 100° C. to about 150° C., such as about 130° C., for a duration of about 10 min to about 30 min, such as about 20 min.

In some illustrative embodiments, the membrane body MB may have a pore network where, on a 3D lattice network, pore bodies are located at substantially regular lattice points, pore throats connecting at least some of the pore bodies. The Pore throats can be oriented in several different directions. For example, these directions may reach up to 13 different orientations and, depending on a pre-specified network average, a coordination number of pore bodies up to 26 (from 0 to 26) may be provided in a regular cubic lattice in 3D network, whereas these numbers substantially increase in a circular 3D lattice.

In some special illustrative examples, the inventor provide on the basis of Literature, for example using Genetic Algorithm which is recommended to optimize the design when irregular properties such as continuity, differentiability, etc. . . . , objective functions that need to be optimized, the following data samples results of porosity calculation on a 3D cubic structure of a porous medium of porosity of about 10% to 20%, preferably in the range from about 12% to about 14%. An exemplary membrane body may be provided as follows: number of pores 5030; number of bonds 7605; mean coordination number ˜3; number of bonds to inlet 238; number of bonds to outlet 219; porosity (%) 13.5.

In some illustrative embodiments, the membrane body may have pores with porous sizes as follows. In this regard it is noted that the International Union of Pure and Applied Chemistry (IUPAC) divides porous materials into three classes based on their pore diameter (d): microporous d<2.0 nm, mesoporous 2.0≤d≤ 50 nm and macroporous d>50 nm. In this respect, silica and titanium are characterized as mesoporous materials containing pores with diameters between about 2 nm and 50 nm.

In accordance with some other illustrative embodiments, other engineering options of increasing the porosity of TiO₂ are presented as follows. It is noted in this regard that a lattice reconstruction strategy to grow porous titanium dioxide may be given as follows. Single crystals considering synergistic control of porous microstructure, structural coherence and band gap engineering considerably enhances for example the functionalities of the P-SC anatase TiₙO₂ₙ₋₁ (n=7-38) in Magnéli phases.

In an illustrative example, an exemplary method may be based on a method, comprising growing P-SC TiₙO₂ₙ₋₁ crystals. Firstly, single-crystalline KTP substrates are grown, e.g., using the Czochralski method, followed by cutting them into substrates with dimensions of about 10 mm×about 20 mm×about 0.5 mm without limitation. Then, the surfaces may be mechanically polished while the crystal facets and roughness may be analyzed using XRD on an Xray diffractometer (Cu-Kα, Mniflex 600) and atomic force microscopy (AFM, Bruker Dimension Edge), respectively. Then, the P-SC TiₙO₂ₙ₋₁ crystals may be grown in a vacuum system with H₂/Ar gas (50-200 sccm, 6 N purity) pressure controlled at 67-333 mbar at 600-800° C. The P-SC TiₙO₂ₙ₋₁ crystals may be obtained after maintaining the treatment duration for 30-60 h followed by a natural cooling process in argon gas (6 N purity).

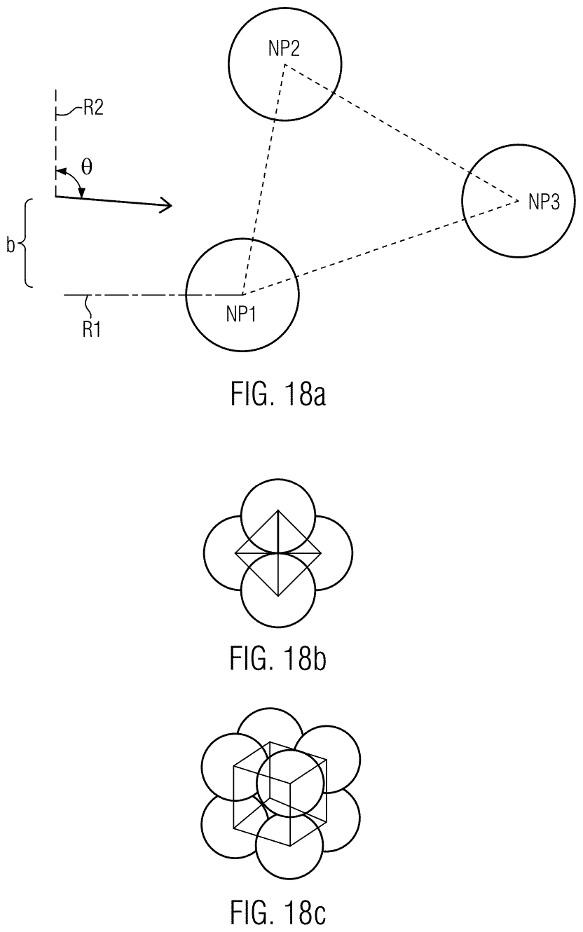

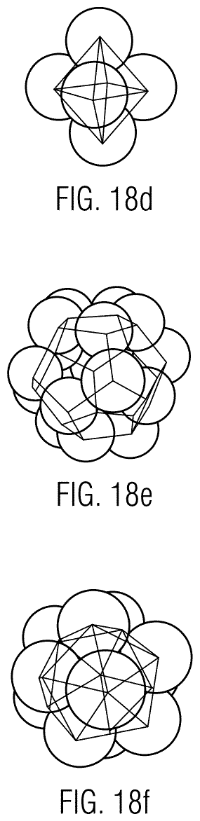

In accordance with some other illustrative embodiments to be discussed with reference to FIG. 18a, transparent structures with a three-disk geometry can be used to trigger a chaotic scattering in a very specific way which can be understood when taking the theory of chaotic scattering in high chaotic dimensions such as Fractal, Wada, Riddled. In accordance with illustrative embodiments, a light confinement structure LCS' is shown, comprising a substrate (corresponding to the paper plane in the illustration of FIG. 18a, possibly the upper surface US of the membrane body MB in FIG. 14) having nanoparticles NP1, NP2, and NP3 formed thereon. In some illustrative embodiments, the nanoparticles NP1 to NP3 may have a maximum size of less than about 300 nm. For example, the nanoparticles NP1 to NP3 may have a semi sphere like shape and/or a spacing between nanoparticles NP1 to NP3 is at least about 2.048 times an average radius of the nanoparticles NP1 to NP3. The nanoparticles NP1 to NP3 may be formed of at least one of silica glass, ferritin, heat-shock proteins, vault proteins and protein nanocages.

In some preferred embodiments herein, the nanoparticles NP1 to NP3 have a maximum size of less than about 300 nm and have a sphere-like shape with a spacing between the nanoparticles NP being at 2.04821419 times an average radius of the nanoparticles NP1 to NP3. Such a spacing provides for a basin boundary metamorphosis which is a result of homoclinic interactions of stable and unstable manifolds, finding an exact critical point for this exact spacing.

FIG. 18a shows a regular triangular arrangement of the three spherical nanoparticles NP1, NP2, and NP3 which, as described above, may represent three nanoparticles out of a multitude of nanoparticles (not illustrated) such that the arrangement illustrated in FIG. 18a may be a repetitive arrangement of a repeating triangular pattern. This simplified illustration is only presented for explaining the appearance of the critical point at the spacing between the nanoparticles NP1, NP2, NP3 being at 2.04821419 times an average radius of the nanoparticles NP1, NP2, NP3. The inventor point out that, when the nanoparticles are in close contact with each other, such as the nanoparticles NP1, NP2, NP3 coming in close contact in the illustration of FIG. 18a, there is a critical geometric point that trajectories of light propagating between nanoparticles become tangents to the nanoparticles.

With ongoing referent to FIG. 18a incoming light is indicated by an arrow with orientation @ relative to a reference direction R2 vertical to a reference direction R1 and having a scattering parameter b indicating a height to reference R1. In the phase space of the trajectories of such incoming light specified by e and b, intersections between unstable manifolds a specific topological border occur at a critical value of the spacing between the nanoparticles. This critical point is known in dynamic systems as a heteroclinic orbit, and refers to phase space path joining two different equilibrium points. The inventor performed a calculation of this critical geometric point for the configuration of nanoparticles shown in FIG. 18a via symmetry reduction by choosing symmetry lines as a Poincaré section and found that the system undergoes topological chaos, periodic orbits proliferate proportional to the entropy. The inventor found that, in terms of symmetry reduction, the system can be equated in reference to a two-symbol topological Bernoulli shift where at this point an intersection mapping can be determined using several methods such as the Birkhoff's method of symmetry lines. In the end, the spacing given by a relation between the centers of two spheres resulted in 4/√3=2.309401. Following a calculation as presented in Hansen K T 1992 Chaos 2 71; 1993 Nonlinearity 6 753,770; 1992 Symbolic dynamics: III. Bifurcation in billiards and smooth spaces and making use of Hansen's constant the exact critical point at 2.04821419 was found. It is noted that a shaded area in FIG. 18a represents the chaotic dimension which in this case is the Wada basin dimension.

Although FIG. 18a shows an illustrative example in which the three nanoparticles NP1 to NP3 are arranged in accordance with an equilateral triangle, at the corners of which the nanoparticles NP1 to NP3 are positioned, this is not limiting and any regular polygonal arrangement may be realized instead, e.g., a regular polygon such as a square or regular hexagon or regular octagon etc.

With respect to FIGS. 18b to 18f, 3D arrangements in accordance with further illustrative embodiments of the present disclosure are schematically shown, wherein each of FIGS. 18b to 18f show plural agglomerations of nanoparticles in which nanoparticles are suitably arranged for being located on a surface of a substrate (not illustrated) of a light confining structure (not illustrated). In addition to polygonal arrangements as described above with respect to FIG. 18a, polyhedral arrangements of nanoparticles are possible. FIG. 18b shows nanoparticles arranged as a regular tetrahedron mirror ball structure, FIG. 18c shows nanoparticles arranged as a regular hexahedron, FIG. 18d shows nanoparticles arranged as a regular octahedron, FIG. 18e shows nanoparticles arranged as a regular dodecahedron, and FIG. 18f shows nanoparticles arranged as a regular icosahedron.

As shown in each of the FIGS. 18a to 18f, nanoparticles in contact with an underlying substrate (not illustrated) are provided as spheres or may be provided as semi-spheres, instead. For example, semi-spheres in contact with the substrate, such as a glass box, may be provided by etching. Accordingly, any of the spherical nanoparticles as shown in FIGS. 18a to 18f in contact with the substrate, may be provided as semi-spherical nanoparticles. The nanoparticles, may be formed on a surface of the underlying substrate (not illustrated), preferably a substrate prepared by an optically transparent material, such as glass or a silicon oxide base substrate, e.g., single crystal silicon oxide. In some special illustrative but non-limiting examples herein, a substrate is not necessarily of a planar and/or disc shape but may be provided by any other carrier or support structure such as a glass/transparent box. For example, outer spheres could be adhered/glued on the top of sides of the glass box. Accordingly, the person skilled in the art will appreciate after a complete lecture of the present application that a certain arrangement geometry may be formed depending on an intended application and taking a desired optical storage capacity into account.

In any of the arrangements as described above with respect to FIGS. 18b to 18f, the evaluation and findings as disclosed above with respect to FIG. 18a apply in a straight forward manner to any of the FIGS. 18b to 18f such that the nanoparticles in any of FIGS. 18b to 18f have a maximum size of less than about 300 nm and have a sphere-like shape with a spacing between the nanoparticles being at 2.04821419 times an average radius of the nanoparticles.

Referring to any of FIG. 18a to FIG. 18f, nanoparticles may be spherical nanoparticles which are attached to a surface of a planar structure, e.g., a substrate. For example, the nanoparticles may be adhered or glued onto a planar surface using any of the methods as suggested below.

Although FIG. 18a to FIG. 18f show spherical nanoparticles, this does not impose any limitation onto the present disclosure and ellipsoidal and/or semi-ellipsoidal nanoparticles may be provided instead.

In some illustrative and non-limiting examples, the nanoparticles may be glued through quantum dots. For example, oligomers consisting of two monomers may be joined by bonds that can be either strong or weak, covalent or intermolecular which are usually referred as dimers. In a special illustrative example, dimer shaped Ag nanoparticles can prepared in colloidal form by controlled addition of linking polymer or salt to Ag nanosphere colloid. When mixed, linker molecules may act as glue to stick two larger sized nanoparticles. Because this glue is tiny, further attachment of nanoparticles to the same spot is prevented, creating the desired dimer structure. In some other illustrative examples, it is possible to position a CdTe quantum dot between two larger nanospheres in colloidal solution.

In some other illustrative and non-limiting examples, the nanoparticles may be glued through superamphiphobic fluorosilane. For example, a stable superamphiphobic surface can be prepared with a film of carbon nanospheres by means of a twostep method in which fluorosilane can glue loose carbon nanospheres. An according gluing is inexpensive and suitable for large-scale preparation of superamphiphobic surface, therefore allowing a cheap and time-saving fabrication of the embodiments as disclosed above with respect to any of FIGS. 18a to 18f, the fabrication being easy to control.

In some other illustrative and non-limiting examples, the nanoparticles may be attached via adhesion. In examples herein, nanospheres may be suspended in dichloromethane or in tetrahydrofuran instead of ethanol. In both cases the addition of polyimide dissolved in dichloromethane or in THE results in clear solutions, but with dichloromethane clear, homogeneous and stable coatings on glass wafers are easily achieved. Thus, a coating with a mixture of 20 mg polyimide and 6.19*1011 gold/silica core/shell particles per 1 ml dichloromethane may be used.

After a complete lecture of the present disclosure, nanoparticles may be formed in some illustrative but non-limiting embodiments as nanospheres which may be provided on a substrate via nanolithography. In an explicit but non-limiting example herein, nanospheres may be provided as follows: in a first step, nanoparticles may be produced in colloids and afterwards the colloids may be coated with a silica layer.

For example, for nanoparticles with small diameters, e.g., in a range from about 10 to 30 nm such as at about 15 nm, nanoparticles may be produced via reduction of tetrachloroauric acid by sodium citrate. In an explicit but non-limiting example herein, 95 mg tetrachloroauric acid may be dissolved in 500 ml of an aqueous liquid, e.g., water, by stirring. An accordingly obtained solution may be heated up to at least 100° C., e.g., to about 150° C. Subsequently, 24 ml of a solution of sodium citrate (e.g., 1% m/v) may be added during stirring. The reaction lasts for ˜20 min at this temperature.

For example, for nanoparticles with bigger diameters, e.g., in a range from about 30 to 80 nm such as at about 60 nm, nanoparticles may have an absorption maximum in the longer wavelength range. For producing according nanoparticles with spherical shape, a seeded growth synthesis may be used for the production of such larger nanoparticles. In an explicit but non-limiting example herein, 150 ml of 2.2 mM sodium citrate may be heated to at least 80° C., e.g., to 100° C. Afterwards, 1 ml of 25 mM tetrachloroauric acid may be added. Subsequently, the solution may be heated for at least 5 min, such as for about 10 min. For the seeding process to take place, the temperature may then be reduced by about 10° C., such as to 90° C. in case of a previous heating to 100° C. After reaching the appropriate temperature, 1 ml tetrachloroauric acid may be added again and stirred for at least 20 min, such as for about 30 min. The addition of tetrachloroauric acid may be repeated. Then, 55 ml of this nanoparticle suspension may be diluted with 53 ml of an aqueous liquid, such as water. Then, 2 ml of 60 mM sodium acetat-solution may be added and stirred at about 90° C. This is preferably repeated in each growing step. Each step may also include the following: addition of 1 ml of 25 mM tetrachloroauric acid and may be stirred for 30 min. Furthermore, 1 ml of 25 mM tetrachloroauric acid may be added before the next dilution with 53 ml of aqueous liquid, such as water, before the next growth step.

After a complete lecture of the present disclosure, the person skilled in the art will appreciate that dielectric nanoparticles with core and shell, e.g., dielectric/silica shell core/shell nanoparticles with a core diameter of at least 5 nm, e.g., at about 15 nm, pure dielectric colloids may be coated with a silica shell. Herein, aminopropyltrimethoxysilane may be used in an illustrative but non-limiting example as a coupling agent, i.e., used as a primer. The silica shell may be obtained by using tetraethoxysilane via a Stöber synthesis.

In an illustrative but non-limiting example herein, 25 ml of a dielectric suspension may be used and 0.228 mL of an aqueous solution of 1 mM aminopropyltrimethoxysilane may be added and stirred for at least 10 min, e.g., for about 15 min. After that, a solution of active silica (27 wt %) may be diluted to 0.4 to 0.6 wt %, e.g.-, to about 0.54 wt %, at a pH of greater 10, e.g., about 11, and 1 ml thereof may be added under stirring. The reaction may take place during about 6 days on a rocking shaker. Afterwards, 1 ml batches of particles are purified and transferred in each case in a solution of 0.2 ml of an aqueous liquid, e.g., water, and 0.8 ml ethanol. Then, 12 μl tetraethoxysilane (10 vol %) and 10 μl ammonium hydroxide (25% v/v) may be added. The reaction takes place over night in an overhead-shaker. The particles may be purified one time in ethanol and stored in ethanol.

With reference to FIG. 14 and in accordance with some illustrative embodiments, an upper bound on the spacing between nanoparticles NP may be in the range from about 6 to about 1000, preferably in the range from about 6 to about 10 or in the range from about 100 to about 1000.

According to some illustrative embodiments, the porous membrane body MB may be formed of a dielectric material, e.g., at least one of TiO₂ and SiO₂. For example, the porous membrane body MB may be manufactured by providing a powder of the dielectric material, e.g., by grinding or crushing the dielectric material. Then, the nanoparticles NP may be deposited onto the powder, e.g., by plasma deposition techniques, followed by compactifying the accordingly processed powder, e.g., sintering the powder with nanoparticles NP into the membrane body MB.

With regard to some special illustrative examples, TiO₂ may be considered as fine if its granularity is given by an average grain size of about 100-3,000 nm and ultrafine with an average grain size of smaller than about 100 nm. In some advantageous but non-limiting examples herein, an average grain size may be in the range from about 200 nm to about 300 nm where the inventor found that scattering of light by TiO₂ is maximized.

With regard to some other special illustrative examples, nanoparticles of SiO₂ may have an average granular size of about 12 mm to about 4 mm. For example, SiO₂ may be 99.99% pure, when used as nanoparticles NP in the membrane body MB.

Referring to FIG. 14, a possible application of the light energy storage structure LESS is schematically shown. As illustrated, the light emitting storage structure LESS is exposed to light, such as sun light rays SLR emitted by the sun S as a non-limiting and exemplary light source.

The person skilled in the art will appreciate in view of the present disclosure that the nanoparticles NP of the light energy storage structure LESS may cause chaotic scattering of the sun light rays SLR entering the membrane body MB via pores P exposed to the sun light rays SLR. In some illustrative examples, the nanoparticles NP may be distributed over the membrane body MB such that the nanoparticles NP are not too close to each other, i.e., a spacing of the nanoparticles NP may be greater than 2.0482142 times an average or maximum radius of the nanoparticles NP.

Referring to FIG. 15, an illustrative application of a light energy storage structure LESS' in an energy storage and/or conversion system 700′. According to some illustrative embodiments herein, the energy storage and/or conversion system 700′ comprises a container 741′ in which the light energy storage structure LESS' is located. The light energy storage structure LESS' may be arranged within the container 741′ after being exposed to light energy or, alternatively, the light energy storage structure LESS' may be arranged within the container 741′ and be exposed to light energy by means of an optical waveguide, such as one of the optical waveguides (not illustrated) described above and being optically coupled with the light energy storage structure LESS' such that light harvested by the optical waveguide (not illustrated) as described above, is transmitted by the optical waveguide (not illustrated) to the light energy storage structure LESS′. The container 742′ may be filled with a liquid 743′, the liquid 743′ may correspond to the liquid 743 as described above, the disclosure of which is incorporated by reference.

For example, during an operation of the system 700′ for converting light energy into thermal energy, light stored in the light energy storage structure LESS' is released by the liquid 743′ within the container 741′ being in contact with the light energy storage system LESS′. For example, the container 741′ may be filled with the liquid 743′ once it is intended to release the light energy stored within the light energy storage structure LESS′.

A release of light energy stored in the light energy storage system LESS' may occur when the overall system's energy demand needs to release light energy to any technology (Concentrated Solar Panel, Photovoltaic, Solar Desalination technologies, Artificial Photo-Synthesis for production of solar fuels such as Hydrogen, Ethanol and others). For example, a computer-automation system (not illustrated) could trigger an optical signal for liberating photons from the light energy storage structure LESS' and be released onto the container 741′ as a thermal storage tank or alternatively a photovoltaic panel (not illustrated), an artificial photosynthesis solar fuel system (not illustrated), or any solar-based system or technology. Thus, the container 741′ of the system 700′ may be automatically controlled to be displaced into the container 741′ filled with the liquid 743′ through a double door system (not illustrated) so the existing thermal energy may be kept.

It is noted that light stored in the light energy storage structure LESS' may escape from such a nanostructured scattering body if impact parameters of incoming orbits are statistically distributed according to a probability density ρ₀(s), where corresponding time delays {t≡−T(s;E)} at an energy E have the probability density: p(t;E)=∫dsρ₀(s)δ[t+T(s;E)] (EQ 2). This means that light energy stored in the light energy storage structure LESS' may be kept until its release is triggered by an external optical pulse which basically is an optical pulse that satisfies EQ 2 (probability density), breaking the fractal dimension and therefore acting as an optical faucet.

FIG. 15 shows the light energy storage structure LESS' in an energy storage and/or conversion system 700′. However, this is not a particular limitation and the light energy storage structure LESS' can be placed on top or on the sides of the container 741′, wherein optical coupling between the light energy storage structure LESS' and the liquid 743′ is achieved through an optical window portion allowing optical coupling of light emitted from the light energy storage structure LESS' through the optical window portion, e.g., a transparent wall portion of the container 741′ such as a glass window and the like. Alternatively, the light energy storage structure LESS' may be placed in the container 741′ above the liquid 743′ without being in direct mechanical contact with the liquid 743′. In either way, the light energy storage structure LESS' avoids direct contact with high temperatures of the liquid 743′.

The membrane body MB, MB′ as described above with regard to FIG. 14, 15 may be employed in the context of FIG. 17 as described above, where the substrate SUB of FIG. 17 may be provided by at least one of the membrane bodies MB, MB′ as described above.

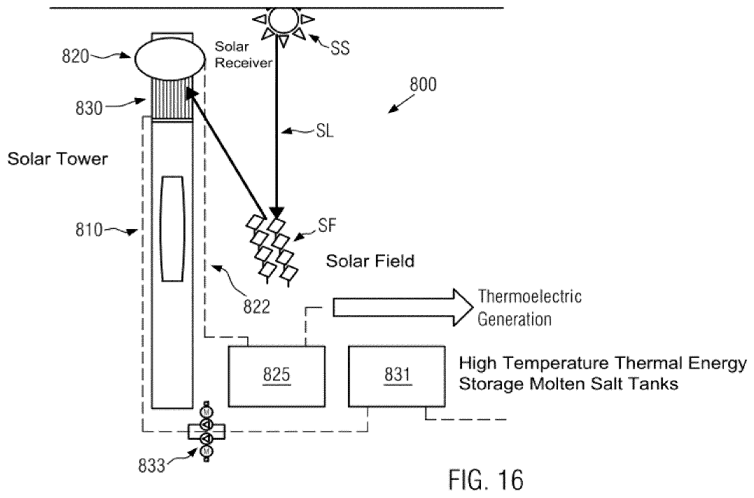

Now referring to FIG. 16, an energy storage and/or conversion system 800 in accordance with some illustrative embodiments is schematically shown. The energy storage and/or conversion system 800 comprises an optical storage 820 and a container (not illustrated) of an energy storage and/or conversion system (not illustrated) being connected to the optical storage 820 with an optical waveguide (not illustrated), where the optical waveguide (not illustrated) and the energy storage and/or conversion system (not illustrated) may correspond to an optical waveguide and energy storage and/or conversion system as described above, the disclosure of which is incorporated by reference. That is, the container (not illustrated) of the energy storage and/or conversion system (not illustrated) may correspond to one of the containers 741 and 741′ as described above, the disclosure of which is incorporated by reference. The container (not illustrated) may have a light energy storage structure (not illustrated) as described above with regard to FIG. 14 arranged therein or optically coupled to the container as described above with regard to FIG. 15. Additionally or alternatively, the light confining structure as described above with regard to any of FIG. 17, and 18a to 18f may be arranged in the container or optically coupled to the container through a window. Accordingly, the optical storage 820 may comprise a light energy storage structure as described above, the disclosure of which is incorporated by reference, and/or the light confining structure as described above, the disclosure of which is incorporated by reference. Accordingly, light energy, depicted as light rays SL of the sun SS as an illustrative but non-limiting example of a light source, is collected by the energy storage 820 and transmitted to the container (not illustrated) by the optical waveguide (not illustrated).

In accordance with some illustrative embodiments and as illustrated in FIG. 16, the optical storage 820 may be located on top of a tower 810. The light rays SL may be collected by a field of mirrors SF and directed by the mirrors of the field of mirrors SF to the optical storage 820 such that the light emitted by the light source SS is collected and concentrated towards the optical storage 820 on the tower 810. For example, the tower 810 may be encircled by a solar field of flat mirrors (heliostats) represented in FIG. 16 for illustrative purposes and without limitation as the field of mirrors SF.

Alternatively or additionally and as illustrated in FIG. 16, the energy storage and/or conversion system 800 may have a tank 831 (which may correspond to the container as described above with regard FIG. 15) in which a molten salt mix, like sodium nitrate and potassium nitrate, is stored. The molten salt mix of the tank 831 is circulated by a pump 833 via a conduit to the top of the tower 810 where it is heated by sunlight SL reflected by mirrors SF onto a receiver atop the tower 810. This molten salt is cycled up the tower “cold”, e.g. at 260° C., and is then heated by focused sunlight SL aimed at the receiver from the field of mirrors SF. Once heated, e.g., at about 565° C., molten salt flows down the tower via a conduit 822 where it can either be used right away to generate electricity or be stored thermally in a hot tank 825 for use later.

In some illustrative examples herein, a heat exchanger 830 is located atop the tower 810, integrated into or coupled with a receiver (not illustrated) of concentrated solar power (CSP), thereby implementing the energy storage and/or conversion system 800 into a CSP plant. For example, the heat exchanger may be integrated into or coupled with the receiver (not illustrated) which may be a circular Fresnel reflector (not illustrated) located atop the tower 810. The receiver (not illustrated) may contain a heat-transfer fluid. For example, the working fluid in the receiver (not illustrated) may be heated to about 500° C. to about 1000° C. (773-1,273 K or 932-1,832° F.) and then used as a heat source for a power generation or energy storage system as described above.

The person skilled in the art will appreciate that the power tower may have different systems to bring the heated working fluid to the storage tank 825 from the tank 831. Additionally or alternatively, the person skilled in the art will appreciate that incoming rays SLR can also be diffused (through a light diffuser—not illustrated) before reaching the receiver and/or the light energy storage structure 820.

After a complete lecture of the present disclosure, the person skilled in the art will appreciate that at least some illustrative embodiments may provide for a new CSP plant where it is possible to easily get rid of the tower system, including the receiver and the entire system to take heat down to the tanks. For example, in an energy storage and conversion system, only a light energy storage structure and optionally at least one optical waveguide may be used for harvesting and/or transporting and/or releasing stored light energy.

In accordance with some modifications to FIG. 16, a diffuser (not illustrated) could be used for diffusing incoming focused rays from mirrors so as to avoid concentrated focus light heating up in one spot.

The person skilled in the art will appreciate that an energy storage and/or conversion system may be adapted to existing CSP plants by basically optically coupling a light energy storage structure to a receiver of the CSP plant, depending on each installation.

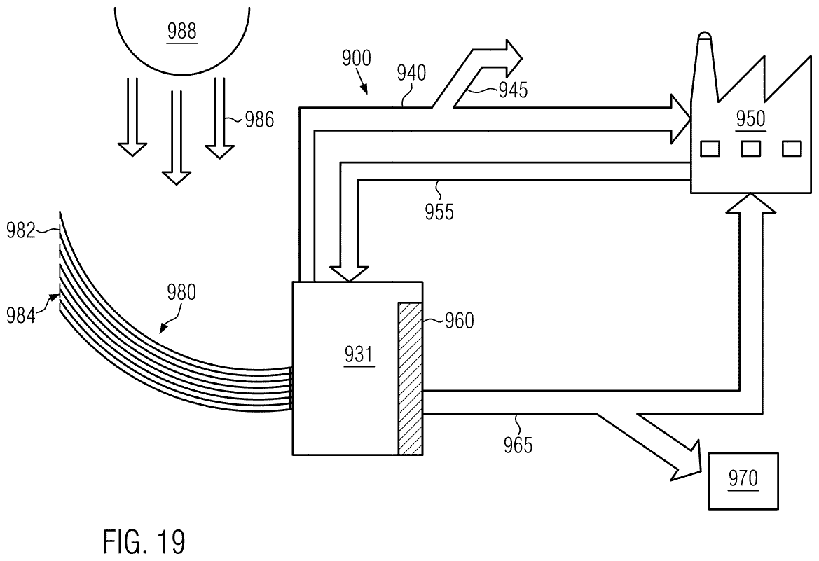

FIG. 19 shows energy storage and/or conversion system 900 including a thermal storage and electric conversion unit 931 which may correspond to the tank 831 and/or the container 741 as described above, the disclosure of which is incorporated by reference in its entirety. That is, the thermal storage and electric conversion unit 931 may be a container in accordance with one of the containers described above, the disclosure of which is incorporated by reference. Accordingly, the thermal storage and electric conversion unit 931 may comprise a light energy storage structure (not illustrated) as described above with regard to FIG. 14 arranged therein or optically coupled to the thermal storage and electric conversion unit 931 in analogy to the disclosure provided above with regard to FIG. 15. Additionally or alternatively, the light confining structure as described above with regard to any of FIG. 17, and 18a to 18f may be arranged in the thermal storage and electric conversion unit 931 or optically coupled to the interior of the thermal storage and electric conversion unit 931 through a window. Accordingly, the thermal storage and electric conversion unit 931 may comprise a light energy storage structure as described above, the disclosure of which is incorporated by reference, and/or the light confining structure as described above, the disclosure of which is incorporated by reference, optically coupled therewith (either incorporated therein or coupled therewith). Accordingly, light energy confined by the light confining structure may be released and optically coupled to the thermal storage and electric conversion unit 931 indirectly by one or more optical waveguides corresponding to the optical waveguides disclosed herein or directly via direct optical coupling.

However, the thermal storage and electric conversion unit 931 may have a heat exchanger in thermal contact with a steam system for generating hot steam (e.g., at a high temperature greater than 400° C. or in a range from about 100° C. to about 400° C.) that may be supplied via a steam supply system 940 with a consumer 950. The consumer 950 may use the hot steam for heating or generating energy and supply unused steam back via an optional feedback system 955. The steam supply system 940 may optionally provide a low temperature steam connection for supplying low temperature steam (e.g., at a temperature in a range from about 100° C. to 400° C. or below 100° C., depending on the temperature of the hot steam in the steam supply system 940 being smaller or greater 400° C.) branched off from the steam supply system 940 via a low temperature steam supply 945.

In accordance with some illustrative embodiments, the thermal storage and electric conversion unit 931 may additionally or alternatively comprise a conversion unit 960 for converting thermal energy to electric energy, supplying electric energy into an electric energy grid 965 for supplying electric energy to the consumer 950 and/or to one or more further consumers 970. For example, thermal energy may be converted to electric energy via a turbine (not illustrated) using steam produced within the thermal storage and electric conversion unit 931 or one or more thermoelectric elements. Although not illustrated, an electric feedback connection terminal for feeding back electric energy may be provided, wherein the electric feedback connection terminal may be coupled to one or more thermoelectric elements generating electric energy.

With ongoing reference to FIG. 19, the energy storage and/or conversion system 900 comprises an optical waveguide system 980 having a plurality of optical waveguides 982 each of which corresponding to the optical waveguide of the first aspect of the disclosure and/or the optical waveguide described above. The plurality of optical waveguides 982 may be arranged so as to cover a two-dimensional area (530, 630, 720) or three-dimensional arrangement (714) at a first end 984 of the plurality of optical waveguides 982, wherein ends of a first subset the plurality of optical waveguides 982 at the first end 984 are arranged substantially in parallel at their first ends and across ends of a second subset of the plurality of optical waveguides 982 at the first end 984. For example, the plurality of optical waveguides 982 may be interwoven at the first end 984. However, this is not limiting the present disclosure and the ends of the plurality of optical waveguides 982 may be all in parallel at the first end 984. Accordingly, the plurality of optical waveguides 982 may harvest sun light 986 emitted by the sun 988 very efficiently.

Although FIG. 19 is illustrated as including an optical waveguide system 980, this does not impose any limitation on the present disclosure and the person skilled in the art will appreciate that the optical waveguide system 980 is optional and may not be present in some illustrative embodiments (not illustrated). In according embodiments (not illustrated), the thermal storage and electric conversion unit 931 is directly optically coupled to a light energy storage structure (not illustrated) and/or a light confining structure (not illustrated). For example, the light energy storage structure (not illustrated) and/or a light confining structure (not illustrated) may be arranged within the thermal storage and electric conversion unit 931 and/or coupled to the thermal storage and electric conversion unit 931 via one or more window portions (not illustrated) provided in the thermal storage and electric conversion unit 931.

An energy storage and/or conversion system according to the present disclosure, e.g., one of the systems 700, 800 and 900 as described above, may be supplied with high levels of concentration of photonic energy. Herein, optical waveguide systems, such as at least one of the systems 710 and 980 as described above, provide for integral capture of sun light along optical waveguides acting as transmission lines, thereby providing the capacity of exponentially increasing the performance of thermal energy storage in the energy storage and/or conversion system. Accordingly, high-temperature thermal energy storage (known in the art as HTTES) may be provided in an efficient manner.

In the illustrative embodiments of the energy storage and/or conversion system according to the present disclosure, e.g., one of the systems 700, 800 and 900 as described above, it is the idea to employ materials or compound materials which can enhance and/or sustain high temperatures, increase the storage time, and can deliver electricity in form of electric conductors. For example, an inside coating employed in the energy storage and/or conversion system according to the present disclosure may be made of ceramics for mixing with graphite. Illustrative examples herein may comprise aluminum oxide (Al₂O₃), and TiO₂ and MgO sintered with graphite. In some preferred embodiments resulting in preferred mechanical properties and also having an electrical conductivity in the range of 95-110 S/m, a ceramics graphite mix may comprise graphite in a range of about 25 to 35 wt % and aluminum oxide (Al₂O₃) graphite in a range of about 65 to 75 wt %.

In the illustrative embodiments of the energy storage and/or conversion system according to the present disclosure, e.g., one of the systems 700, 800 and 900 as described above, the interior of the thermal storage and electric conversion unit 931, the tank 831 and the container 741, respectively, may be coated with three layers: an overall interior/exterior case, an insulator, and composite material layer. The overall interior/exterior case may be provided by a high temperature encasing configured to sustain high temperatures greater 200° C., such as an encasing made of steel or similar support. The insulator may provide an insulation made of a combination of coke/coal/carbon powder/carbon felt or a ceramic fiber or rock wool. The composite material layer may be a composite mix of ceramics and graphite such as the inside coating as described above. This composite material layer can be surrounding the entire inner wall of the thermal storage and electric conversion unit 931, the tank 831 and the container 741, respectively, where the insulator is, or it could incorporate additional boards made with the ceramics/graphite mix placed and spaced out alongside the height or width of the thermal storage and electric conversion unit 931, the tank 831 and the container 741, respectively.

Referring to FIG. 19, the thermal storage and electric conversion unit 931 may have three connections connecting the thermal storage and electric conversion unit 931 via appropriate connection terminals with exterior supply systems providing thermal and electric energy to consumers: two output streams, one for coupling to the steam supply system 940 and another for coupling to the electric energy grid 965, and the optional feedback system 955 such as a steam feedback from connected consumers, e.g., industry consumers. For example, industry consumers may be iron and steel industry which usually requires 79% of thermal energy and 21% of electricity. As described above, the steam supply system 940 may be split in two subsystems: one subsystem providing up to 200° C. for low thermal energy and the other subsystem providing more than 400° C., e.g., up to 2000° C., for high thermal energy supply. In accordance with some illustrative examples herein, the energy storage and/or conversion system 900 may be used daily based on energy demand profiles representative of a direct iron reduction facility to model a high-temperature end-user. For example, the energy storage and/or conversion system 900 may provide an energy supply output consisting of 79% heat, 21% electricity, and the application temperature ranges from 150° C. for boiler use to at least 400° C., preferably more than 800° C. for iron ore reduction.

With regard to any embodiment as disclosed in the context any of FIGS. 14, 15, 17, and 18a to 18f, electromagnetic (EM) energy can be released to any technology (concentrated solar panel, photovoltaic, solar desalination technologies, artificial photo-synthesis for production of solar fuels such as hydrogen, ethanol and others) upon a computer-automation system triggering an optical signal to liberate photons from the structure and be released onto a thermal storage tank, a photovoltaic panel, an artificial photosynthesis solar fuel system, or any solar-based system or technology. For example, in the case of a thermal storage tank, such as any of the embodiments as described above with regard to FIGS. 16 and 19, a substrate's or membrane's macrostructure (surface, film, or membrane) may be automatically controlled to be displaced into and/or optically coupled, e.g., through a window, to a liquid-filled tank through a double door system so the existing thermal energy is kept. In the case of a photovoltaic, such a macrostructure may be on top of the photovoltaic cell. Light can escape from a nanostructured scatter if impact parameters of incoming orbits are statistically distributed according to a probability density at an energy E.

FIGS. 16 and/or 19 may be considered as representing illustrative embodiments of a “meta energy grid global infrastructure” which the inventor refers to as “MEGGIE”.

The various aspects and embodiments of the present disclosure as described above evolved in project works of the inventor which the inventor collectively collectively subsumes under the term “complex energy”.

1. An optical waveguide, comprising:
an optical fiber with a fiber core; and
an optical active cladding structure over at least a portion of the fiber core at a first end of the optical waveguide,
wherein the optical active cladding structure comprises:
a Bragg mirror stacking having a high transmittance in a first wavelength region and a high reflectivity in a second wavelength region of wavelengths longer than wavelengths in the first wavelength region, and
a wavelength conversion coating over the fiber core of the optical fiber, the wavelength conversion coating being configured to convert radiation with wavelengths in the first wavelength region into radiation with wavelengths in the second wavelength region,
wherein the Bragg mirror stacking is disposed over the wavelength conversion coating.

2. The optical waveguide of claim 1, wherein the wavelength conversion coating comprises a wavelength conversion dye that is configured to emit radiation with wavelengths in the second wavelength region by stimulated emission upon being irradiated with radiation with wavelengths in the first wavelength region, and/or wherein the first wavelength region is located between about 380 nm and about 700 nm and the second wavelength region is located between about 700 nm and about 1.4 μm.

3. The optical waveguide of claim 1, wherein the optical fiber has an air core and a glass or polymeric cladding bordering the air core.

4. The optical waveguide of claim 1, wherein the wavelength conversion coating is configured to enhance fluorescence via a plasmonic enhancement function with surface plasmons.

5. The optical waveguide of claim 4, wherein the wavelength conversion coating further comprises a nanoparticle film and a silicon oxide or silica matrix material which covers the nanoparticle film and over which the Bragg mirror stacking is disposed, and/or wherein the nanoparticle film has a thickness in a range from about 500 nm to about 3 μm.

6. The optical waveguide of claim 5, wherein the nanoparticle film comprises nanoparticles with a size in the range from about 5 nm to about 100 nm and a shell having a thickness in the range from about 1 nm to about 80 nm.

7. The optical Optical-waveguide of claim 1, wherein the optical active cladding structure is formed such that the optical fiber is at least partially covered by the wavelength conversion coating in a region at the first end.

8. The optical Optical-waveguide of claim 1, wherein the optical fiber is completely covered by the Bragg mirror coating along its entire length and/or its entire circumference.

9. The optical Optical-waveguide of claim 1, wherein the optical waveguide has a length in a range from about 5 nm-to-up to about 25,000 km.

10. An optical waveguide system, comprising plural ones of the optical waveguide of claim 1, wherein at least some of the optical waveguides are arranged so as to cover a two-dimensional area or three-dimensional arrangement at the first ends of these optical waveguides, wherein the first ends of these optical waveguides are arranged substantially in parallel at their first ends.

11. The optical Optical-waveguide system of claim 10, wherein the optical waveguides comprise a first subset of optical waveguides with their first ends being arranged substantially in parallel and a second subset of optical waveguides with their first ends being arranged substantially in parallel, wherein the optical waveguides of the first and second subsets are interwoven at their first ends such that the optical waveguides of the first subset extend across the optical waveguides of the second subset at their first ends.

12. A light confining structure that relies on a disordered geometry structure, comprising:
a substrate of a non-absorbing material;
nanophotonic resonators provided by one of a structure of nanophotonic cavities formed in a surface of the substrate and a structure of quantum dots formed on the surface of the substrate; and
a micro- or nanoparticle structure formed on the surface of the substrate, wherein the micro- or nanoparticle structure comprises shells of low relative permittivity smaller 1 and cores of a dielectric material, each shell enclosing at least two cores on the surface of the substrate.

13. The light confining structure according to claim 12, wherein the shells are formed of an optically transparent dielectric matrix material.

14. The light confining structure according to claim 12, wherein the shells have a relative permittivity smaller 0.5 or smaller 0.2 or smaller 0.1 or smaller 0.05.

15. The light confining structure according to claim 12, wherein the substrate is formed of one of a rigid membrane, a flexible membrane, a rigid film and a flexible film.

16. The light confining structure according to claim 12, wherein the shells are formed of a dielectric material or a plasmonic material.

17. The light confining structure according to claim 16, wherein the shells are formed of a metallic or non-metallic plasmonic material.

18. The light confining structure according to claim 12, wherein the cores are made of one of porcelain, mica, and quartz, or an organic material, preferably an organic polymer.

19. The light confining structure according to claim 12, wherein the cores have core diameter of in a range from about 100 nm to about 1 μm.

20. The light confining structure according to claim 12, wherein the shells are of a size greater than 100 nm and/or cores enclosed by shells have a nearest neighbor separation in a range from about 100 nm to about 1 μm.

21. The light confining structure according to claim 12, wherein the cores are provided in the shape of at least one of a cylindrical shape and an ellipsoidal shape and a nanorod shape and a spherical shape and a nanotube shape and a nanowire shape.

22. The light confining structure according to claim 12, wherein the shells are provided in the shape of at least one of a semi-spherical shape and a semi-ellipsoidal shape.

23. The light confining structure according to claim 12, wherein the cores enclosed by a shell are arranged in a substantially linear arrangement.

24. The light confining structure according to claim 12, wherein nanophotonic resonators are provided by a structure of quantum dots formed of InAs quantum dots, at least some of which having nanophotonic cavities formed therein.

25. The light confining structure according to claim 12, wherein the nanophotonic resonators are provided by a structure of holes formed in the substrate.

26. The light confining structure according to claim 25, wherein the holes are substantially circular holes having a diameter in a range from about 100 nm to about 500 nm, preferably in a range from about 100 nm to about 300 nm or in a range from about 150 nm to about 500 nm, and more preferably in a range from about 150 nm to about 300 nm.

27. The light confining structure according to claim 12, wherein the nanophotonic resonators are provided with a filling fraction of about 50% to 85% and/or the shells have a center diameter in a range of 200-400 nm and/or cores enclosed by shells have a nearest neighbor separation in a range of 460-700 nm.

28. The light confining structure according to claim 27, wherein the filling fraction has a variance in a range of about 5% to about 20% and/or the center diameter has a variance of 10% to about 40% and/or the nearest neighbor separation has a variance in a range of about 10% to about 40%.

29. A light confining structure, comprising:
a substrate of a non-absorbing material; and
a micro- or nanoparticle structure formed on a surface of the substrate, wherein the micro- or nanoparticle structure comprises micro- or nanoparticles arranged in at least one agglomeration of a regular polygonal or polyhedral shape where the micro- or nanoparticles are located on vertices of the regular polygonal or polyhedral shape.

30. The light confining structure according to claim 29, wherein a nearest neighbor separation of the nanoparticles in each agglomeration have a separation of at least 2.048 times an average radius of the nanoparticles.

31. The light confining structure according to claim 29, wherein the nanoparticles have an average radius of at most 150 nm.

32. The light confining structure of claim 12, wherein the substrate is formed of at least one of TiO₂ and SiO₂ and/or wherein the substrate is a porous membrane body formed of a dielectric material and having nanoparticles deposited on at least a surface portion of the porous membrane body and/or wherein the nanoparticles are formed of at least one of silica glass, ferritin, heat-shock proteins, vault proteins and protein nanocages.

33. A light energy storage structure, comprising a porous membrane body formed of a dielectric material and nanoparticles deposited on at least a surface portion of the porous membrane body.

34. The light energy storage structure of claim 33, wherein the nanoparticles have a maximum size of less than about 300 nm and/or the nanoparticles have a sphere-like or semi sphere like shape and/or a spacing between nanoparticles is at least about 2.048 times an average radius of the nanoparticles and/or the nanoparticles are formed of at least one of silica glass, ferritin, heat-shock proteins, vault proteins and protein nanocages.

35. The light energy storage structure of claim 33, wherein the porous membrane body is formed of at least one of TiO₂ and SiO₂.

36. A light energy storage system comprising:
the optical waveguide system of claim 10, and
at least one of a light energy storage structure comprising a porous membrane body formed of a dielectric material and nanoparticles deposited on at least a surface portion of the porous membrane body, and
a light confining structure that relies on a disordered geometry structure,
wherein the light confining structure comprising:
a substrate of a non-absorbing material;
nanophotonic resonators provided by one of a structure of nanophotonic cavities formed in a surface of the substrate and a structure of quantum dots formed on the surface of the substrate; and
a micro- or nanoparticle structure formed on the surface of the substrate, wherein the micro- or nanoparticle structure comprises shells of low relative permittivity smaller 1 and cores of a dielectric material, each shell enclosing at least two cores on the surface of the substrate, and
wherein the light confining structure is arranged at each end of the optical waveguide system or the optical waveguide.

37. An energy storage and/or conversion system, comprising a container for storing therein a liquid, wherein the container has an inner surface being composed of a nonlinear juxtaposition of heat resistance ceramic tiles and/or the container contains a liquid comprising microstructures and/or nanostructures dispersed in the liquid for confining electromagnetic radiation, and/or highly conductive composites and graphite immersed therein.

38. An energy storage and/or conversion system, comprising:
a container for storing therein a liquid, wherein the container has an inner surface being composed of a nonlinear juxtaposition of heat resistance ceramic tiles and/or the container contains a liquid comprising microstructures and/or nanostructures dispersed in the liquid for confining electromagnetic radiation, and/or highly conductive composites and graphite immersed therein, and
the light energy storage system of claim 36, wherein a second end of the optical waveguide system and/or the optical waveguide opposite the first ends is arranged so as to optically couple radiation emitted from the optical waveguide system to the liquid.

39. The energy storage and/or conversion system of claim 37, wherein the highly conductive composites are made of phase change materials such as a nitrate salt mixture and/or carbon moieties and/or the liquid further comprises nanoparticles having gold cores and/or silver cores and/or copper nanoparticles and/or copper oxide nanoparticles immersed therein.

40. The energy storage and/or conversion system of claim 37, wherein the microstructures and/or nanostructures dispersed in the liquid are composed of cores and filaments acting as shells for the cores.

41. An energy storage and/or conversion system comprising a container for storing therein a liquid, wherein the container has an inner surface being composed of a nonlinear juxtaposition of heat resistance ceramic tiles and/or the container contains a liquid comprising microstructures and/or nanostructures dispersed in the liquid for confining electromagnetic radiation, and/or highly conductive composites and graphite immersed therein,
wherein the system further comprises a light confining structure comprising:
a substrate of a non-absorbing material;
nanophotonic resonators provided by one of a structure of nanophotonic cavities formed in a surface of the substrate and a structure of quantum dots formed on the surface of the substrate; and
a micro- or nanoparticle structure formed on the surface of the substrate,
wherein the micro- or nanoparticle structure comprises shells of low relative permittivity smaller 1 and cores of a dielectric material, each shell enclosing at least two cores on the surface of the substrate and arranged in and/or optically coupled to the container and/or a light energy storage structure, which comprises a porous membrane body formed of a dielectric material and nanoparticles deposited on at least a surface portion of the porous membrane body, arranged in and/or optically coupled to the container.

42. The energy storage and/or conversion system of claim 37, further comprising at least one connection terminal configured for connecting the energy storage and/or conversion system with at least one exterior energy supply system.

43. The energy storage and/or conversion system of claim 42, wherein the at least one connection terminal is configured for connecting the energy storage and/or conversion system with at least one of a steam supply system and an electric energy grid.

44. The energy storage and/or conversion system of claim 42, wherein the at least one connection terminal is configured for connecting with a thermal energy feedback system.

45. A fabrication system for fabrication of an optical waveguide with a Bragg mirror coating, the fabrication system comprising:
a reel on which an optical fiber is provided;
an input iris separating an air environment from a vacuum environment; and
chamber process sections, which are each associated with pumps and irises, wherein the chamber process sections comprise plasma low index and plasma high index sections.

46. The fabrication system according to claim 45, the system further comprising a fabrication section for dye coating and/or a quantum dot coating at a input side upon drawing the optical fiber from the reel.

47. The fabrication system according to claim 45, the system further comprising a fabrication section for coating with nanoparticles.

48. A fabrication system according to claim 45, wherein the fabrication system is configured to fabricate an optical waveguide comprising
an optical fiber with a fiber core; and
an optical active cladding structure over at least a portion of the fiber core at a first end of the optical waveguide,
wherein the optical active cladding structure comprises:
a Bragg mirror stacking having a high transmittance in a first wavelength region and a high reflectivity in a second wavelength region of wavelengths longer than wavelengths in the first wavelength region, and
a wavelength conversion coating over the fiber core of the optical fiber, the wavelength conversion coating being configured to convert radiation with wavelengths in the first wavelength region into radiation with wavelengths in the second wavelength region,
wherein the Bragg mirror stacking is disposed over the wavelength conversion coating.
